(19) United States
(12) Patent Application Publication
(10) Pub. No.: US 2003/0110206 A1
(43) Pub. Date: Jun. 12, 2003

(54) Flow control method for distributed broadcast-route networks

(76) Inventor: Serguei Osokine, Cupertino, CA (US)

Correspondence Address: PERKINS COIE LLP, PATENT-SEA, P.O. BOX 1247, SEATTLE, WA, 98111-1247, US

(21) Appl. No.: 10/115,861

(22) Filed: Apr. 3, 2002

Related U.S. Application Data
(63) Continuation-in-part of application No. 09/724,937, filed on Nov. 28, 2000.
(60) Provisional application No. 60/281,324, filed on Apr. 3, 2001.

(51) Int. Cl. G06F 15/16

(52) U.S. Cl. 709/201; 709/234

(57) ABSTRACT

A method, system, and computer-readable medium is described for providing improved data or other information flow control over a distributed computing or information storage/retrieval network. In some situations, the flow of information is controlled to minimize the data transfer latency and to prevent overloads, such as by controlling the outgoing flow of data (both requests and responses) on the network connection to ensure that no data is sent before the previous portions of data are received by a network peer, by controlling the stream of the requests arriving on the connection and deciding which of them should be broadcast to the neighbors to ensure that the responses to these requests would not overload the outgoing bandwidth of this connection, and/or by multiplexing the logical streams on the connection to ensure that the connection is not monopolized by any of the logical request/response streams from the other connections.

### RELATED APPLICATIONS

This application claims the benefit of U.S. Provisional Application No. 60/281,324 filed Apr. 3, 2001 and entitled “Flow Control Method for Distributed Broadcast-Route Networks,” which is incorporated herein by reference in its entirety. This application is related to U.S. patent application Ser. No. 09/724,937 filed Nov. 28, 2000 and entitled “System, Method and Computer Program for Flow Control In a Distributed Broadcast-Route Network With Reliable Transport Links;” herein incorporated by reference and enclosed as Appendix D.

### FIELD OF INVENTION

This invention pertains generally to systems and methods for communicating information over an interconnected network of information appliances or computers, more particularly to system and method for controlling the flow of information over a distributed information network having broadcast-route network and reliable transport link network characteristics, and most particularly to particular procedures, algorithms, and computer programs for facilitating and/or optimizing the flow of information over such networks.

### BACKGROUND

The Gnutella network does not have a central server and consists of the number of equal-rights hosts, each of which can act in both the client and the server capacity. These hosts are called ‘servents’. Every servent is connected to at least one other servent, although the typical number of connections (links) should be more than two (the default number is four). The resulting network is highly redundant with many possible ways to go from one host to another. The connections (Oinks) are the reliable TCP connections.

When the servent wishes to find something on the network, it issues a request with a globally unique 128-bit identifier (ID) on all its connections, asking the neighbors to send a response if they have a requested piece of data (file) relevant to the request. Regardless of whether the servent receiving the request has the file or not, it propagates (broadcasts) the request on all other links it has, and remembers that any responses to the request with this ID should be sent back on the link which the request has arrived from. After that if the request with the same ID arrives on the other link, it is dropped and no action is taken by the receiving servent in order to avoid the ‘request looping’ which would cause an excessive network load.

Thus ideally the request is propagated throughout the whole Gnutella network (GNet), eventually reaching every servent then currently connected to the network. The forward propagation of the requests is called ‘broadcasting’, and the sending of the responses back is called ‘routing’. Sometimes both broadcasting and routing are referred to as the ‘routing’ capacity of the servent, as opposed to its client (issuing the request and downloading the file) and server (answering the request and file-serving) functions. In a Gnutella network each node or workstation acts as a client and as a server.

Unfortunately the propagation of the request throughout the whole network might be difficult to achieve in practice. Every servent is also the client, so from time to time it issues its own requests. Thus if the propagation of the requests is unlimited, it is easy to see that as more and more servents join the GNet, at some point the total number of requests being routed through an average servent will overload the capacity of the servent physical link to the network.

Since the TCP link used by the Gnutella servents is reliable, this condition manifests itself by the connection refusal to accept more data, by the increased latency (data transfer delay) on the connection, or by both of these at once. At that point the Gnutella servent can do one of three things: (i) it can drop the connection, (ii) it can drop the data (request or response), or (iii) it can try to buffer the data in hope that it will be able to send it later.

The precise action to undertake is not specified, so the different implementations choose different ways to deal with that condition, but it does not matter—all three methods result in serious problems for the Gnet, namely one of A, B, or C, as follows: (A) Dropping the connection causes the links to go up and down all the time, so many requests and responses are simply lost, because by the time the servent has to route the response back, the connection to route it to is no longer available. (B) Dropping the data (request or response) can lead to a response being dropped, which overloads the network by unnecessarily broadcasting the requests over hundreds of servents only to drop the responses later. (C) Buffering the data increases the latency even more. And since it does little or nothing to fix the basic underlying problem (an attempt to transmit more data than the network is physically capable of) it only causes the servents to eventually run out of memory. To avoid that, they have to resort to other two ways of dealing with the connection overload albeit with much higher link latency.

These problems were at least somewhat anticipated by the creators of the Gnutella protocol, so the protocol has a built-in means to limit the request propagation through the network, called ‘hop count’ and ‘TTL’ (time to live). Every request starts its lifecycle with a hop count of zero and TTL of some finite value (de facto default is 7). As the servent broadcasts the request, it increases its hop count by one. When the request hop count reaches the TTL value, the request is not broadcast anymore. So the number of hosts N that see the request can be approximately defined by the equation:

(1) N=(avLinks−1)ˆ TTL, (EQ. 1)

where avLinks is the average number of the servent connections, and the TTL is the TTL value of the request. For the avLinks=5 and TTL=7 this comes to a value of N of about 10,000 servents.

Unfortunately the TTL value and the number of links are typically hard-coded into the servent software and/or set by the user. In any case, there's no way for the servent to quickly (or dynamically) react to the changes in the GNet data flow intensity or the data link capacity. This leads to the state of affairs when the GNet is capable of functioning normally only when the number of servents in the network is relatively small or they are not actively looking for data. When either of these conditions is not fulfilled, the typical servent connections are overloaded with the negative consequences outlined elsewhere in this description. Put simply, the GNet enters the ‘meltdown’ state with the number of ‘visible’ (searchable from the average servent) hosts dropping from the range of between about 1,000-4,000 to a much smaller range or between about 100-400 or less, which decreases the amount of searchable data by a factor of ten or about an order of magnitude. At the same time the search delay (the time needed for the request to traverse 7 hops (the default) or so and to return back as a response) climbs to hundreds of seconds. Response time on the order of hundreds of seconds are typically not tolerated by users, or at the very least are found to be highly irritating and objectionable.

In fact, the delay becomes so high that the servent routing tables (the data structures used to determine which connection the response should be routed to) reach the full capacity, overflow and time out even before the response arrives so that no response is ever received by the requester. This, in turn, narrows the search scope even more, effectively making the Gnutella unusable from the user standpoint, because it cannot fulfill its stated goal of being the file searching tool.

The ‘meltdown’ described above has been observed on the Gnutella network, but in fact the basic underlying problem is deeper and manifests itself even with a relatively small number of hosts, when the GNet is not yet in an actual meltdown state.

The problem is that the GNet uses the reliable TCP protocol or connection as a transport mechanism to exchange messages (requests and responses) between the servents. Being the reliable vehicle, the TCP protocol tries to reliably deliver the data without paying much attention to the delivery latency (link delay). Its main concern is the reliability, so as soon as the data stream exceeds the physical link capacity, the TCP tries to buffer the data itself in a fashion, which is not controlled by the developer or the user. Essentially, the TCP code hopes that this data burst is just a temporary condition and that it will be able to send the buffered data later.

When the GNet is not in a meltdown state, this might even be true—the burst might be a short one. But regardless of the nature of the burst, this buffering increases the delay. For example, when a servent has a 40 kbits/sec modem physical link shared between four connections, every connection is roughly capable of transmitting and receiving about 1 kilobyte of data per second. When the servent tries to transmit more, the TCP won't tell the servent application that it has a problem until it runs out of TCP buffers, which are typically of about 8 kilobyte size.

So even before the servent realizes that its TCP connections are overloaded and has any chance to remedy the situation, the link delay reaches 8 seconds. Even if just two servents along the 7-hop request/response path are in this state, the search delay exceeds 30 seconds (two 8-second delays in the request path and two—in the response path). Given the fact that the GNet typically consists of the servents with very different communication capabilities, the probability is high that at least some of the servents in the request path will be overloaded. Actually this is exactly what can be observed on the Gnutella network even when it is not in the meltdown state despite the fact that most of the servents are perfectly capable of routing data with a sub-second delay and the total search time should not exceed 10 seconds.

Basically, the ‘meltdown’ is just a manifestation of this basic problem as more and more servents become overloaded and eventually the number of the overloaded servents reaches the ‘critical mass’, effectively making the GNet unusable from a practical standpoint.

It is important to realize that there's nothing a servent can do to fight this delay—it does not even know that the delay exists as long as the TCP internal buffers are not yet filled to capacity.

Some developers have suggested that UDP be used as the transport protocol to deal with this situation, however, the proposed attempts to use UDP as a transport protocol instead of TCP are likely to fail. The reason for this likely failure is that typically the link-level protocol has its own buffers. For example, in case of the modem link it might be a PPP buffer in the modem software. This buffer can hold as much as 4 seconds of data, and though it is less than the TCP one (it is shared between all connections sharing the physical link), it still can result in a 56-second delay over seven request and seven response hops. And this number is still much higher than the technically possible value of less than ten seconds and, what is more important, higher than the perceived delay of the competing Web search engines (such as for example AltaVista, Google, and the like), so it exceeds the user expectations set by the ‘normal’ search methods.

Therefore, there remains a need for a system, method, and computer program and communication protocol that minimizes the latency and reduces or prevents GNet or other distributed network overload as the number of servents grows.

There also remains a need for particular methods, procedures, algorithms, and computer programs for facilitating and optimizing communication over such distributed networks and for allowing such networks to be scaled over a broad range.

### BRIEF DESCRIPTION OF DRAWINGS

FIG. 1. The Gnutella router diagram.

FIG. 2. The Connection block diagram.

FIG. 3. The bandwidth layout with a negligible request volume.

FIG. 4. The bandwidth reservation layout.

FIG. 5. The ‘GNet leaf’ configuration.

FIG. 6. The finite-size request rate averaging.

FIG. 7. Graphical representation of the ‘herringbone stair’ algorithm.

FIG. 8. Hop-layered request buffer layout in the continuous traffic case.

FIG. 9. Request buffer clearing algorithm.

FIG. 10. Hop-layered round-robin algorithm.

FIG. 11. Request buffer Q-volume and data available to the RR-algorithm.

FIG. 12. The response distribution over time (continuous traffic case).

FIG. 13. Equation (62) integration trajectory in (tau, t) space.

FIG. 14. Sample Rt(t)*r(t, tau) peak distribution in (tau, t) space in the discrete traffic case.

FIG. 15. Rt(t)*r(t, tau) value interpolation and integration in the discrete traffic case.

FIG. 16. Rt(t)*r(t, tau) integration tied to the Q-algorithm step size.

FIG. 17. Single response interpolation within two Q-algorithm steps.

### SUMMARY

The invention provides improved data or other information flow control over a distributed computing or information storage/retrieval network. The flow, movement, or migration of information is controlled to minimize the data transfer latency and to prevent overloads. A first or outgoing flow control block and procedure controls the outgoing flow of data (both requests and responses) on the network connection and makes sure that no data is sent before the previous portions of data are received by a network peer in order to minimize the connection latency. A second or Q-algorithm block and procedure controls the stream of the requests arriving on the connection and decides which of them should be broadcast to the neighbors. Its goal is to make sure that the responses to these requests would not overload the outgoing bandwidth of this connection. A third or fairness block makes sure that the connection is not monopolized by any of the logical request/response streams from the other connections. It allows to multiplex the logical streams on the connection, making sure that every stream has its own fair share of the connection bandwidth regardless of how much data are the other streams capable of sending. These blocks and the functionality they provide may be used separately or in conjunction with each other. As the inventive method, procedures, and algorithms may advantageously be implemented as computer programs, such as computer programs in the form of software, firmware, or the like, the invention also advantageously provides a computer program and computer program product when stored on tangible media. Such computer programs may be executed on appropriate computer or information appliances as are known in the art, and may typically include a processor and memory couple to the processor.

### DETAILED DESCRIPTION OF EMBODIMENTS

Exemplary embodiments of the inventive system, method, algorithms, and procedures are now described relative to the drawings. For the convenience of the reader, the description is organized into sections as outlined below. It will be appreciated that aspects of the invention are described throughout the specification and that the section notations and headers are merely for the convenience of the reader and do not limit the applicability or scope of the description in any way.

1.Introduction

2. Finite message size consequences for the flow control algorithm

3. Gnutella router building blocks

4. Connection block diagram

5. Blocks affected by the finite message size

6. Packet size and sending time

6.1. Packet size

6.2. Packet sending time

7. Packet layout and bandwidth sharing

7.1. Simplified bandwidth layout

7.2. Packet layout

7.3. ‘Herringbone stair’ algorithm

7.4. Multi-source ‘herringbone stair’

8. Q-algorithm implementation

8.1. Q-algorithm latency

8.2. Response/request ratio and delay

8.2.1. Instant response/request ratio

8.2.2. Instant delay value

9. Recapitulation of Selected Embodiments

10. References

Appendix A. ‘Connection 0’ and request processing block

Appendix B. Q-algorithm step size and numerical integration

Appendix C. OFC GUID layout and operation

Appendix D. U.S. patent application Ser. No. 09/724,937 (Reference [1])

### 1. Introduction

The inventive algorithm is directed toward achieving the infinite scalability of the distributed networks, which use the ‘broadcast-route’ method to propagate the requests through the network in case of the finite message size. The ‘broadcast-route’ here means the method of the request propagation when the host broadcasts the request it receives on every connection it has except the one it came from and later routes the responses back to that connection. ‘Finite message size’ means that the messages (requests and responses) can have the size comparable to the network packet size and are ‘atomic’ in a sense that another message transfer cannot interrupt the transfer of the message. That is, the first byte of the subsequent message can be sent over the communication channel only after the last byte of the previous message.

Even though the algorithm described below can be used for various networks with the ‘broadcast-route’ architecture, the primary target of the algorithm is the Gnutella network, which is widely used as the distributed file search and exchange system. The system and method may as well be applied to other networks and are not limited to Gnutella networks. The Gnutella protocol specifications (herein incorporated by reference) are known, incorporated by reference herein, and can be found at the web sites identified below, the contents of which are incorporated by reference:

http://gnutella.wego.com/go/wego.pages.page?groupId=116705&view=page&pageId=119598&folderId=116 767&panelId=−1&action=view

http://www.gnutelladev.com/docs/capnbra-protocol.html

http://www.gnutelladev.com/docs/our-protocol.html

http://www.gnutelladev.com/docs/gene-protocol.html

To achieve the infinite scalability of the network, it is desirable to have some sort of the flow control algorithm built into it. Such an algorithm for Gnutella and other similar ‘broadcast-route’ networks was described in U.S. patent application Ser. No. 09/724,937 filed Nov. 28, 2000 and entitled System, Method and Computer Program for Flow Control In a Distributed Broadcast-Route Network With Reliable Transport Links; herein incorporated by reference and enclosed as Appendix D, and identified as reference [1] in the remainder of this description. The flow control procedure and algorithm was designed on an assumption that the messages can be broken into the arbitrarily small pieces (continuous traffic case). This is not always the case—for example, the Gnutella messages are atomic in a sense mentioned above (several messages cannot be sent simultaneously over the same link) and can be quite large—several kilobytes. Thus it is desirable to adopt the continuous-traffic flow control algorithm to the situation when the messages are atomic and have finite size (discrete traffic case). This adaptation and the algorithms that achieve it are the subject of this specification. At the same time this document describes some further details of a particular flow control implementation.

### 2. Finite Message Size Consequences for the Flow Control Algorithm

The flow control algorithm described in [1] uses the continuous-space equations to monitor and control the traffic flows and loads on the network. That is, all the variables are assumed to be the infinite-precision floating-point numbers. For example, the typical equation ([1], Eq. 13—describes the rate of the traffic to be passed to other connections) might look like this:

x=(Q−u)/Rav (1)

where x is the rate of the incoming forward-traffic (requests) passed by the Q-algorithm to be broadcast on other connections.

The direct implementation of such equations would mean that when, say, 40 bytes of requests would arrive on the connection, the Q-algorithm might require that 25.3456 bytes of this data should be forwarded for the broadcast and 14.6544 bytes should be dropped. This would not be possible for two reasons—first, it is not possible to send a non-integer number of bytes, and second, these 40 bytes might represent a single request.

The first obstacle is not very serious—after all, we might send 25 bytes and drop 15 bytes. The resulting error would not be a big one, and a good algorithm should be tolerant to the computational and rounding errors of such magnitude.

The second obstacle is worse—since the message (in this case, request) is atomic, it is not possible to break it into two parts, one of which would be sent, and another would be dropped. We have to drop or to send the whole request as an atomic unit. Thus regardless of whether we decide to send or to drop the messages which cannot be fully sent, the Q-algorithm would treat all the messages in the same way, effectively passing all the incoming messages for broadcast or dropping all of them. Such a behavior would introduce an error, which would be too large to be tolerated by any conceivable flow control algorithm, so it is clearly unacceptable and we have to invent some way to deal with this situation.

The similar problem arises when the fair bandwidth-sharing algorithm tries to allocate the space for the requests and responses in the packet to be sent out. Let's say we would like to evenly share the 512-byte packet between requests and responses, and it turns out that we have twenty 30-byte requests and a single 300-byte response—what should one do? Should one send a 510-byte packet with the response and 7 requests, and then send a 90-byte packet with 3 responses, or should we send a 600-byte packet with a response and 10 requests? The first decision would not evenly share the packet space and bandwidth, possibly resulting in the unfair bandwidth distribution, and the second would increase the connection latency because of the increased packet size. And what if the response is bigger than 512 bytes to begin with?

Such decisions can have a significant effect on the flow control algorithm behavior and should not be taken lightly. So first of all, let's draw a diagram of the Gnutella message routing node and see where are the blocks where these decisions will have to be made.

### 3. Gnutella Router Building Blocks

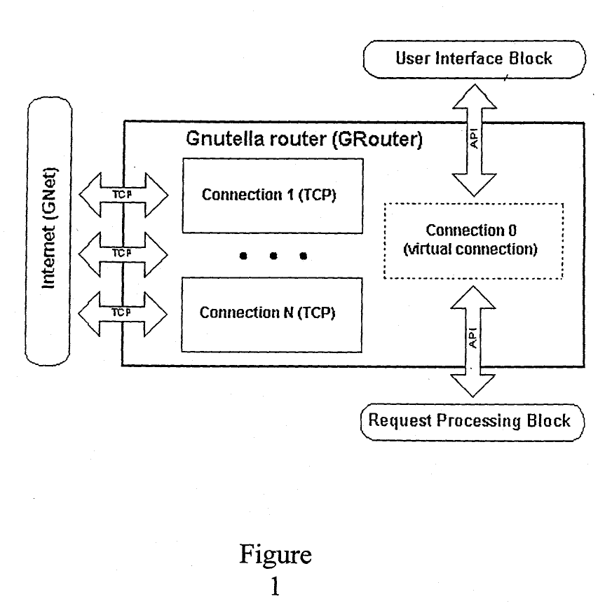

The FIG. 1 presents the high-level block diagram of the Gnutella router (the part of the servent responsible for the message sending and receiving):

Essentially the router consists of several TCP connection blocks, each of which handles the incoming and outgoing data streams from and to another servent and of the virtual Connection 0 block. The latter handles the stream of requests and responses of the router's servent User Interface and of the Request Processing block. This block is called ‘Connection 0’, since the data from it is handled by the flow control algorithms of all other connection in a uniform fashion—as if it has come from the normal TCP Connection block. (See, for example, the description of the fairness block in [1].)

As far as the TCP connections are concerned, the only difference between Connection 0 and any TCP connection is that the requests arriving from this “virtual” connection might have a hop value equal to −1. This would mean that these requests have not arrived from the network, but rather from the servent User Interface Block through the “virtual” connection—these requests have never been transferred through the Gnutella network (GNet). The diagram shows that Connection 0 interacts with the servent UI Block through some API; there are no requirements to this API other than the natural one—that the router and the UI Block developers should be in agreement about it. In fact, this API might closely mimic the normal Gnutella TCP protocol on the localhost socket, if this would seem convenient to the developers.

The Request Processing Block is responsible for the servent reaction to the request—it processes the requests to the servent and sends back the results (if any). The API between the Connection 0 and the Request Processing Block of the servent obeys the same rules as the API between Connection 0 and the servent's User Interface Block—it is up to the servent developers to agree on its precise specifications.

The simplest example of the request is the Gnutella file search request—then the Request Processing block performs the search of the local file system or database and returns back the matching filenames (if found) as the search result. But of course, this is not an only imaginable example of the request—it is easy to extend the Gnutella protocol (or to create another one) to deliver the ‘general requests’, which might be used for many purposes other than the file searching.

The User Interface and the Request Processing Blocks together with their APIs (or even the Connection 0 block) can be absent if the Gnutella router (referred to as “GRouter” for convenience in the specification from now on) works without the User Interface or the Request Processing Blocks. That might be the case, for example, when the servent just routes the Gnutella messages, but is not supposed to initiate the searches and display the search results, or is not supposed to perform the local file system or database searches.

The word ‘local’ here does not necessarily mean that the file system or the database being searched is physically located on the same computer that runs the GRouter. It just means that as far as the other servents are concerned, the GRouter provides an access point to perform searches on that file system or database—the actual physical location of the storage is irrelevant. The algorithms presented here were specifically designed in such a way that regardless of the API implementation and its throughput the GRouter might disregard these technical details and act as if the local interface was just another connection, treating it in a uniform fashion. This might be especially important when the local search API is implemented as a network API and its throughput cannot be considered infinite when compared to the TCP connections' throughput. Thus such a case is just mentioned here and won't be presented separately—it is enough to remember that the Connection 0 can provide some way to access the ‘local’ file system or database.

In fact, one of the ways to implement the GRouter is to make it a ‘pure router’—an application that has no user interface or request-processing capabilities of its own. Then it could use the regular Gnutella client running on the same machine (with a single connection to the GRouter) as an interface to the user or to the local file system. Other configurations are also possible—the goal here was to present the widest possible array of implementation choices to the developer.

However, it might be the case that the Connection 0 would be present in the GRouter even if it does not perform any searches and has no User Interface. For example, it might be necessary to use the Connection 0 as an interface to the special requests' handler. That is, there might be some special requests, which are supposed to be answered by the GRouter itself and would be used by the GNet itself for its own infrastructure-related purposes. One example of such a request is the Gnutella network PING, used (together with its other functions) internally by the network to allow the servents to find the new hosts to connect to. Even if all the GRouter connections are to the remote servents, it might be useful for it to answer the PING requests arriving from the GNet. In such a case the Connection 0 would handle the PING requests and send back the corresponding responses—the PONGs, thus advertising the GRouter as being available for connection.

Still, in order to preserve the generality of the algorithms' description in this specification we assume that all the blocks shown in the diagram are present. This, however, is not a requirement of the invention itself.

Finally, the word ‘TCP’ in the text and the diagram above does not necessarily mean a regular Gnutella TCP connection, or a TCP connection at all, though this is certainly the case when the presented algorithms are used in the Gnutella network context. However, it is possible to use the same algorithms in the context of other similar ‘broadcast-route’ distributed networks, which might use different transport protocols—HTTP, UDP, radio broadcasts—whatever the transport layers of the corresponding network would happen to use.

Having said that, we'll continue to use the words ‘TCP’, ‘GNet’, ‘Gnutella’, etc throughout this document to avoid the naming confusions—it is easy to apply the approaches presented here to other similar networks or to other networks that would support operation according to the procedures described.

Now let's go one level deeper and present the internal structure of the Connection blocks shown in FIG. 1.

### 4. Connection Block Diagram

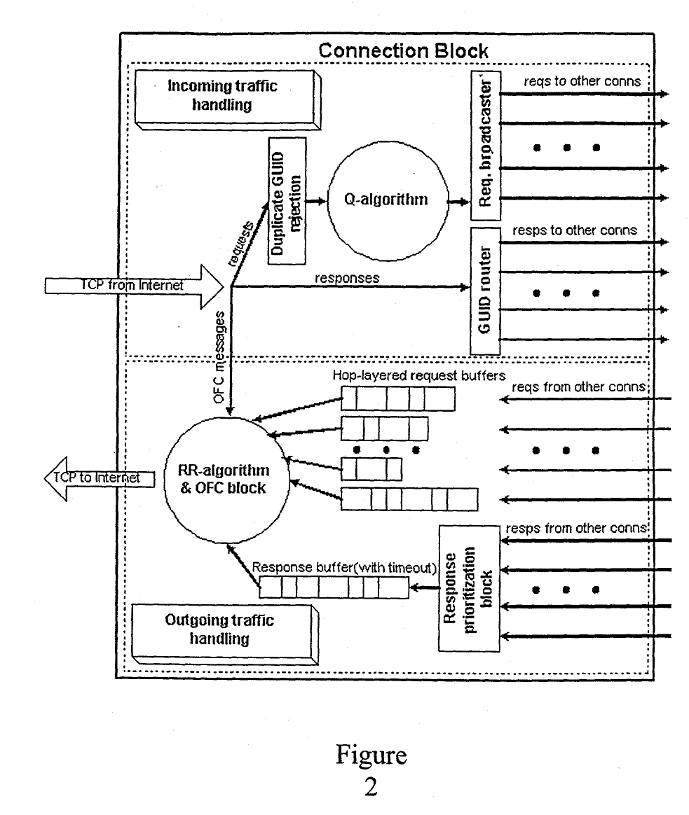

The Connection block diagram is shown in FIG. 2:

The messages arriving from the network are split into three streams:

The requests go through the Duplicate GUID rejection block first; after that the requests with the ‘new’ GUIDs (not seen on any connection before) are processed by the Q-algorithm block as described in [1]. This block tries to determine whether the responses to these requests are likely to overflow the outgoing TCP connection bandwidth, and if this is the case, limits the number of requests to be broadcast, dropping the high-hop requests. Then the requests, which have passed through it go to the Request broadcaster, which creates N copies of each request, where N is the number of the GRouter TCP connections to its peers (N-1 for other TCP connections and one for the Connection 0). These copies are transferred to the corresponding connections' hop-layered request buffers and placed there—low-hop requests first. Thus if the total request volume will exceed the connection sending capacity, the low-hop requests will be sent out and the high-hop requests dropped from these buffers.

The responses go to the GUID router, which determines the connection on which this response should be sent on. Then the response is transferred to this connection's Response prioritization block. The responses with the unknown GUIDs (misrouted or arriving after the routing table timeout) are just dropped.

The messages used by the Outgoing Flow Control block [1] (OFC block) internally, are transferred directly to the OFC block. These are the ‘OFC messages’ in FIG. 2. This includes both the flow-control 0-hop, 1-TTL PONGs, which are the signal that all the data preceding the corresponding PINGs has already been received by the peer and possibly the 0-hop, 1-TTL PINGs. The former are used by the OFC block for the TCP latency minimization [1]. The latter can appear in the incoming TCP stream if the other side of the connection uses the similar Outgoing Flow Control block algorithm. However, the GRouter peer can insert these messages into its outgoing TCP stream for the reasons of its own, which might have nothing to do with the flow control.

The messages to be sent to the network arrive through several streams:

The requests from other connections. These are the outputs of the corresponding connections' Q-algorithms.

The responses from other connections. These are the outputs of the other connections' GUID routers. These messages arrive through the Response prioritization block, which keeps track of the cumulative total volume of data for every GUID, and buffers the arriving messages according to that volume, placing the responses for the GUIDs with low data volume first. So the responses to the requests with an unusually high volume of responses are sent only after the responses to ‘normal’, average requests. The response storage buffer has a timeout—after a certain time in buffer the responses are dropped. This is because even though the Q-algorithm does its best to make sure that all the responses can fit into the outgoing bandwidth, it is important to remember that the response traffic has the fractal character [1]. So it is a virtual certainty that from time to time the response rate will exceed the connection sending capacity and bring the response storage delay to an unacceptable value. The ‘unacceptable value’ can be defined as the delay which either makes the large-volume responses (the ones near the buffer end) unroutable by the peer (the routing tables are likely to time out), or just too large from the user viewpoint. These considerations determine the choice of the timeout value—it might be chosen close to the routing tables overflow time or close to the maximum acceptable search time (100 seconds or so for the Gnutella file-searching application; this time might be different if the network is used for other purposes).

The OFC messages are the messages used internally by the Outgoing Flow Control block. These messages can either control the output packet sending (in case of the 0-hop, 1-TTL PONGs—see [1]) or just have to cause an immediate sending of the PONG in response (in case of the 0-hop, 1-TTL PINGs). When the algorithm described here is implemented in the context of the Gnutella network, it is useful to remember that the PONG message carries the IP and file statistics information. So since the GRouter's peer might include the 0-hop, 1-TTL PINGs into its outgoing streams for the reasons of its own—which might be not flow-control-related—it is recommended to include this information into the OFC PONG too. Of course, this recommendation can be followed only if such information is available and relevant (the GRouter does have the local file storage accessible through some API).

All these messages are processed by the ‘RR-algorithm & OFC block’ [1], which decides when and which messages to send; it is this block which implements the Outgoing Flow Control and Fair Bandwidth Sharing functionality described in [1]. It decides how much data can be sent over the outgoing TCP connection, and how the resulting outgoing bandwidth should be shared between the logical streams of requests and responses and between the requests from different connections. In the meantime the messages are stored in the hop-layered request buffers in case of the requests and in the response buffer with timeout in case of the responses.

The OFC messages are never stored—the PONGs are just used to control the sending operations, and the PINGs should cause the immediate PONG-sending. Since it has been recommended in [1] to switch off the TCP Nagle algorithm, this PONG-sending operation should result in an immediate TCP packet sending, thus minimizing the OFC PONG latency for the OFC algorithm on the peer servent. Note that if the peer servent does not implement the similar flow control algorithm, we cannot count on it doing the same—it is likely to delay the OFC PONG for up to 200 ms because of its TCP Nagle algorithm actions. This might result in a lower effective outgoing bandwidth of the GRouter connection to such a host; however, if the 512-byte packets are used, the resulting connection bandwidth can be as high as 25-50 kbits/sec. Still, it is expected that the connection management algorithms would try to connect to the hosts that use the similar flow control algorithms on the best-effort basis.

It should be noted that this approach to OFC PING handling effectively excludes the OFC PONGs from the Outgoing Flow Control algorithm. Since these PONGs are sent at once and thus have the highest priority in the outgoing stream, a DoS attack is possible when the attacker floods its peers with 0-hop, 1-TTL PINGs and causes them to send only PONGs on the connections to the attacker. This can be especially easy to achieve when the attacked hosts have an asymmetric (ADSL or similar) connection.

However, this attack is likely to cause the extremely high latency and/or TCP buffer overflow on the attacked host's connection to the attacker and result in the connection being closed, which would terminate the attack, as far as the attacked host is concerned. Furthermore, this attack would not propagate over the GNet since by definition it can be performed only with 1-TTL PINGs, which can travel only over 1-hop distance.

### 5. Blocks Affected by the Finite Message Size

The diagrams presented in the previous sections show the GRouter and the flow control algorithm building blocks and the interaction between them. These diagrams essentially illustrate the flow control algorithm as presented in [1]—no assumptions were made so far about the algorithm changes necessary to allow for the atomic messages of the finite size.

However, FIG. 2 makes it easy to see what parts of the GRouter are affected by the fact that the data flow cannot be treated as a sequence of the arbitrarily small pieces. The affected blocks are the ones that make the decisions concerning the individual messages—requests and responses. Whenever the decision is made to send or not to send a message, to transfer it further along the data stream or to drop—this decision necessarily represents a discrete ‘step’ in the data flow, introducing some error into the continuous-space data flow equations described in [1]. The size of the message can be quite large (at least on the same order of magnitude as the TCP packet size of 512 bytes suggested in [1]). So the blocks that make such decisions implement the special algorithms which would bring the data flow averages to the levels required by the continuous flow control equations.

The blocks that have to make the decisions of that nature and which are affected by the finite message size are shown as circles in FIG. 2. These are the ‘Q-algorithm’ block and ‘RR-algorithm & OFC block’.

The ‘Q-algorithm’ block tries to determine whether the responses to the requests coming to it are likely to overflow the outgoing TCP connection bandwidth, and if this is the case, limits the number of requests to be broadcast, dropping the high-hop requests. The output of the Q-algorithm is defined by the Eq. 13 in [1] and is essentially a percentage of the incoming requests' data that the Q-algorithm allows to pass through and to be broadcast on other connections. This percentage is a floating-point number, so it is difficult to broadcast an exact percentage of the incoming request data within a finite time interval—there's always going to be an error proportional to the average request size. However, it is possible to approximate the precise percentage value by averaging the finite data size values over a sufficiently large amount of data. The description of such an averaging algorithm will be presented further in this document.

The ‘RR-algorithm & OFC block’ has to assemble the outgoing packets from the messages in the hop-layered request buffers and in the response buffer. Since these messages have finite size, typically it is impossible (and not really necessary) to assemble the exactly 512-byte packet or to achieve the precise fair bandwidth sharing between the logical streams coming from different buffers as defined in [1] within a single TCP packet. Thus it is necessary to introduce the algorithms that would define the packet-filling and packet-sending procedures in case of the finite message size. These algorithms should desirably follow the general guidelines described in [1], but at the same time they should desirably be able to work with the (possibly quite large) finite-size messages. That means that these algorithms should desirably achieve the general flow control and the bandwidth sharing goals and at the same time should not introduce the major problems themselves. For example, the algorithms should not make the connection latency much higher than the latency that is inevitably introduced by the presence of the large ‘atomic’ messages.

To summarize, the algorithms required in the finite-size message case can be roughly divided into three groups:

The algorithms which determine when to send the packet and how big that packet should be.

The algorithms which decide what messages should be placed in the packet in order to achieve the ‘fair’ outgoing bandwidth sharing between the different logical sub-streams.

The algorithms which define how the requests should be dropped if the total broadcast of all requests is likely to overload the connection with responses.

These algorithm groups are described below:

### 6. Packet Size and Sending Time

The Outgoing Flow Control block algorithm [1] suggests that the packet with messages should have the size of 512 bytes and that it should be sent at once after the OFC PONG is received, which confirms that all the previous packet data has been received by the peer. In order to minimize the transport layer header overhead, the G-Nagle algorithm has been introduced. This algorithm prevents the partially filled packets' sending if the OFC PONG has been already received, but the G-Nagle timeout time TN (˜200 ms) has not passed yet since the last packet sending operation. This is done to prevent the large number of very small packets being sent over the low-latency (<200 ms roundtrip time) links.

This short description of the Outgoing Flow Control block operation leaves out some issues related to the packet size and to the time when it should be sent. The rest of this section explains these issues in detail.

6.1. Packet Size.

The packet size (512 bytes) has been chosen as a compromise between two contradictory requirements. First, it should be able to provide a reasonably high connection bandwidth for the typical Internet roundtrip time (˜30-35 kbits/sec@150 ms), and second, to limit the connection latency even on the low-bandwidth physical links (˜900 ms for the 33 kbits/sec modem link shared between 5 connections).

So this packet size value requirement does not have to be adhered to precisely. In fact, different applications may choose a different packet size value or even make the packet size dynamic, determining it in run-time from the channel data transfer statistics and other considerations. What is important is to remember that the packet size growth can increase the connection latency—for example, the modem link mentioned above can have the latency as high as 1,800 ms if the packet size is 1 KByte.

Which brings an interesting dilemma: what if the message size is higher than 512 bytes? Even if nothing else is transmitted in the same packet, placing just this one message into the packet can lead to the noticeable latency increase. The Gnutella v.0.4 protocol, for example, limits the message size with at least 64 KBytes (actually the message field size is 4 bytes, so formally the messages can be even bigger). Should the OFC block transmit such a message as a single packet, break it down into multiple packets or just drop it altogether, possibly closing the connection?

In practice the Gnutella servents often choose the third path for the practical reasons, limiting the message size with various numbers (3 KBytes recommended in [1], 256-byte limit for requests used by some other implementations, etc). But here we will consider the most general situation when the maximum message size can be several times higher than the recommended packet size, assuming that the large messages are necessary for the application under the consideration. It is easier to drop the large packets if the GNet application does not require those than to reinvent the algorithms intended for the large messages if it does.

So the first choice to be made is to whether to send a large message in one packet or to split it between the several packets? Note that these ‘packets’ we are discussing here are the packets in terms of TCP/IP, not in terms of the OFC block, which tries to place the OFC PING as a last message in every packet it sends. Since TCP is a stream-oriented protocol that tries to hide its internal mechanisms from the application-level observer, as far as the application code is concerned, this OFC PING is an only semi-reliable sign of the end of the sent data block. (In fact, it is possible that the peer might lose it and the PING retransmission might be required.) For this reason throughout this document the sequence of data bytes between two OFC PINGs, including the second one of them, is referred to as a ‘packet’—formally speaking, the application-level code cannot necessarily be sure about the real TCP/IP packets used to transmit that data. The packets in terms of TCP/IP protocol are referred to as ‘TCP[/IP] packets’

When the TCP Nagle algorithm is switched off (as recommended in [1]), typically the send( ) operation performed by the OFC block really does result in a TCP/IP packet being immediately sent on the wire. However, this is not always the case. It might so happen that for the reasons of its own (the absence of ACK for the previously sent data, the IP packet loss, small data window, or the like) the TCP layer will accept the buffer from the send( ) command, but won't actually send it at once. When this buffer will be really sent it might be sent in the same TCP packet with a previous or a subsequent buffer. If the OFC block does not break messages into smaller pieces, this is impossible, since the OFC block would perform no sending operation until the previous one would be confirmed by the PONG from the peer. But if the large message is sent in several 512-byte chunks, it can be the case—several of these chunks can be ‘glued together’ by the TCP layer into a single TCP packet.

On the other hand, when a very large (several kilobytes) message is sent in a single send( ) operation, the TCP layer can split it into several actual TCP/IP packets, if the message is too big to be sent as a single TCP/IP packet.

So the decision we are looking for here is not final anyway—the TCP layer can change the TCP/IP packets' layout, and the issue here is what would be the best way to do the send( ) operations, assuming that typically the TCP layer would not change the decisions we wish to make if the Nagle algorithm is switched off.

Assuming for purpose of the next question that the actual TCP/IP packet layout corresponds precisely to the send( ) calls we make in the GRouter, let's ask ourselves a question: what are the advantages and disadvantages of both approaches?

On one hand, sending a big message in a single packet would undoubtedly result in higher connection bandwidth utilization when the OFC algorithm is used. However, this might cause the connection latency to increase and open the way for the big-packet DoS attack. Besides, if the higher connection bandwidth utilization is desirable, it is better to do it in a controlled way—by increasing the packet size from 512 bytes to a higher value instead of relying on the randomly arriving big messages to achieve the same effect. It is also important to remember that in many cases the higher bandwidth utilization can have a detrimental effect on the concurrent TCP streams (HTTP up/downloads, etc) on the same link, so it might be undesirable in the first place.

So the recommended way is to split the big message into several packets. But this might have some negative consequences in the context of the existing network, too—for example, some old Gnutella clients seemed to expect the message to arrive in the single packet and the message that has been split into several packets might cause them to treat it incorrectly. Even though these clients are obviously wrong, if there are enough of these in the network, it might be a cause for concern. Fortunately this is just a backward compatibility problem in the existing Gnutella network, and in this case there is another way to deal with such a problem. Since the Gnutella network message format is clearly documented, it might be a good idea to split the big incoming message into several smaller messages of <=512 bytes each.

In fact, such a solution (when it is possible) is an ideal variant of dealing with big messages. When the big message is split into several messages, it makes it possible to send other messages between these on the same TCP connection—not just on the same physical link, as it is the case when the big message is just split into several TCP packets. This would minimize the latency not only for the different connections on the same physical link, but also for the connection used to transmit such a message. For example, the requests being sent on the same connection would not have to wait until the end of the big message transfer, but could be sent ‘in the middle’ of such a message. As a side benefit, the attempt to perform the ‘big message’ DoS attack would be thwarted by the Response prioritization block in FIG. 2. The resulting sub-messages with a high response volume would be shifted to the response buffer tail, where they might be even purged by the buffer timeout procedure if the bandwidth would not be enough to send those.

To summarize, the GRouter should try to break all the messages into small (<=512 byte) messages. If this is not possible, it should send the big unbreakable messages in the <=512-byte sending operations (TCP packets), unless it is de facto impossible due to the backward compatibility issues on the network. Since it is impossible to append the OFC PING to such a packet (it would be in the middle of the message), these TCP packets should be sent without waiting for the OFC PONGs, and the OFC PING should be appended to the last packet in a sequence. The GRouter should desirably never send the messages with a size bigger than some limit (3 Kbytes or so, depending on the GNet application), dropping these messages as soon as they are received.

The related issue is the GRouter behavior towards the messages that cause the packet overflow—when the message to be placed next into the non-empty packet by the RR-algorithm makes the resulting packet bigger than 512 bytes. Several actions are possible:

First, the message sending can be postponed and the packet of less than 512 bytes can be sent.

Second, the message can be placed into the packet anyway, and the packet, which is bigger than 512 bytes can be sent.

And third, n exactly 512-byte packets (where n>=1) can be sent with the last message head and no OFC PINGs; then a packet with the last message tail and OFC PING should immediately follow this packet (or packets).

The general guideline here is that (backward compatibility permitting) the average size of the packets sent as the result should be as close to 512 as possible. If we designate the volume of the packet before the overloading message as V1, the size of this message as V2, and the desired packet size (512 bytes in our case) as V0, we will arrive to the following average packet size values Vavi:

In the first case,

Vav1=V1 (2)

In the second case,

Vav2=V1+V2 (3)

And in the third case,

Vav3=(V1+V2)/(n+1) (4)

So whenever this choice presents itself, all three (or more, if V2 is big enough to justify n>1) Vavi values should be calculated, and the method, which gives us the lowest value of abs(Vavi−V0) (or some other metrics, if found appropriate) should be used.

6.2. Packet Sending Time.

It has been already mentioned that the packet (in OFC terms) should desirably not be sent before the OFC PONG for the previous packet ‘tail PING’ arrives. That PONG shows that the previous packet has been fully received by the peer. Furthermore, if the PONG arrives in less than 200 ms after the previous sending operation and there's not enough buffered data to fill the 512-byte packet, this smaller packet should not be sent before this 200-ms timeout expires (G-Nagle algorithm).

However, these requirements are introduced by the OFC (Outgoing Flow Control) block [1] for the latency minimization purposes and define just the earliest possible sending time. In reality it might be necessary to delay the packet sending even more. The reason for this is that the sent packet size and its PONG echo time are the only criteria that can be used by the upstream algorithm blocks (RR-algorithm and the Q-algorithm) to evaluate the channel bandwidth, which is needed for these blocks to operate. No other data is available for that purpose, and even though it might be possible to gather various channel statistics, such data would be extremely noisy and unreliable. Typically multiple TCP streams share the same connection and it is very difficult to arrive to any meaningful results under such conditions. In fact, in the absence of the bandwidth reservation block (like the one defined by the RSVP protocol) in the TCP layer of the network stack this task seems to be just plain impossible. Any amount of statistics can be made void at any moment by the start of the FTP or HTTP download by some other application not related to the GRouter.

When the packets have the full 512-byte size, it is possible to approximate the bandwidth by the equation:

B=V0/Trtt, (5)

where B is the bandwidth estimate, V0 is the full packet size (512 bytes) and Trtt is the GNet one-hop roundtrip time, which is the interval between the OFC packet sending time and the OFC PONG (reply to the ‘trailer’ PING of that OFC packet) receiving time.

Even though this bandwidth estimate may not be very accurate under all circumstances and may vary over a wide range in certain circumstances, it is still possible to use it. It can be averaged over the large time intervals (in case of the Q-algorithm) or used indirectly (when the bandwidth sharing is calculated in terms of the parts of packet dedicated to the different logical sub-streams in case of the fair bandwidth-sharing block).

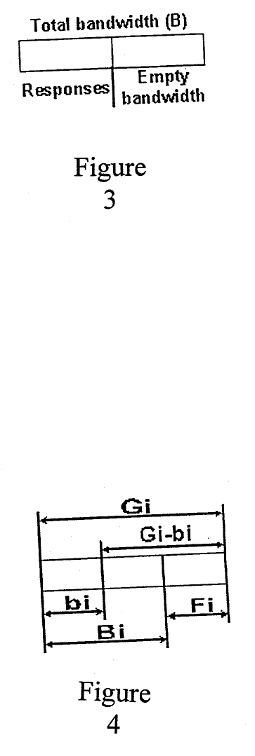

The situation becomes more complicated when there's not enough data to fill the full 512-byte packet at the moment when this packet can be already sent from the OFC block standpoint. Let us consider the model situation when the total volume of requests passing through the GRouter is negligible (each request causes multiple responses in return). Then the connection bandwidth would be used mostly by the responses, and the Q-algorithm would try to bring the bandwidth used by responses to the B/2 level, as shown in FIG. 3:

In order to do that, the Q-algorithm is supposed to know the bandwidth B—otherwise it cannot judge how many requests should it broadcast in order to receive the responses that would fill the B/2 part of the total bandwidth. Let's say that somehow this goal has been reached and the data transfer rate on the channel is currently exactly B/2. Now we want to verify that this is really the case by using the observable traffic flow parameters and maybe make some small adjustments to the request flow if B is changing over time. Would the number of requests' data be enough to fill the ‘empty’ part of the bandwidth in FIG. 3, then (5) could be used to estimate the total bandwidth B. Then the packet volume would be more or less equally shared between the requests and responses, and we should try to reach exactly the same amount of request and response data in the packet by varying the request stream. (Not the request stream in this packet, but the one in the opposite direction, which is not shown in FIG. 3.)

But since there are virtually no requests, in the state of equilibrium (constant traffic stream and roundtrip time) we have to estimate the full bandwidth B using just the size of the packets with back-traffic (response) data V and the GNet roundtrip time Trtt.

The problem is, it is very difficult to estimate the total bandwidth from that data. If we assume that we are sending packets as soon as the OFC PONG arrives and that the sending rate is b, we arrive to the following relationship between V, Trtt and b:

V=b*Trtt (6)

Now, how should we arrive to the conclusion about whether b is less, more or equal to B/2 from that information, if we have no idea what is the value of B? And we need this answer in order to figure out whether to throttle down the broadcast rate, to increase it or to leave it at the same level (Eq. 10 in [1]).

One might expect that if we can effectively change the bandwidth allocation by varying the volume of data in the full (512-byte) packet, we might try to do the same in case of the partially filled packet and estimate the bandwidth B as Bappr=b*V0/V. However, such an approach may not always be successful. The reason for this is that in case of the full packet, its expected average roundtrip time <Trtt> does not change when the packet internal layout is changed; so the response sending rate b is actually related to the full connection bandwidth (5) by the equation:

b=B*V/V0 (7)

This equation can be used only if the packet is full and V is not the packet size, but the size of the response data in this 512-byte packet.

On the contrary, if the packet is just partially filled and V is its total size, its expected roundtrip time Trtt is not constant and might depend on the packet size V. For example, if the connection is sufficiently slow, Trtt might be proportional to V. Then the value of B estimated from (7) as b*V0/V (when V is the total packet size) would give the results that are dramatically different from any reasonably defined total bandwidth B—this estimate would go to infinity as the packet size V goes to zero! In fact, even the state of the equilibrium itself as defined above (constant V, b and Trtt) would be impossible in this case—if Trtt=V/B and V=b*Trtt, then for a constant-rate response stream b

V(t+Trtt)=(b/B)*V(t), (8)

which means that for every response rate b lower than the actual connection bandwidth B, the values of V and Trtt would decline exponentially over time until the G-Nagle timeout or the zero-data roundtip time is reached. That might result in the very small values of V (packet size) and huge bandwidth estimate values, possibly causing the self-sustained uncontrollable oscillations of the request and response traffic defined by the Q-algorithm.

For these reasons, it is highly desirable to introduce a controlled delay into the packet sending procedure in order to evaluate the target channel bandwidth B when the actual traffic sending rate b is less than B. This delay provides an only way to stabilize the packet size V at some reasonable level (V˜V0 and V does not go to zero) when the actual traffic rate b is less than B (defined by (5), if it would be possible to send the full 512-byte packets. Actually this ‘theoretical’ value of B is not directly observable when the total traffic is low and V<V0. The very fact that B is not directly observable under these conditions is what has caused our problems to begin with.)

This delay value (wait time) Tw is defined as the extra time that should pass after the OFC PONG arrival time before the packet should actually be sent and is calculated with the following equations:

| | | | |
|---|---|---|---|
| (9) | Tw = Trtt * (V0 − V)/V, | if | V0/2 <= V <= V0 |
| (10) | Tw = Trtt, | if | V < V0/2 |
| (11) | Tw = 0, | if | V > V0. |

The equations (9-11) assume that the G-Nagle algorithm is not used (Trtt+Tw>=TN; TN=200 ms); if this is not the case, the G-Nagle algorithm takes priority:

| | | | |
|---|---|---|---|
| (12) | Tw = TN − Trtt, | if | Trtt + Tw(from 9-11) < TN and V < V0 |

It is easy to see that in case of the full packet (V=V0 and b=B), Tw=0. The delay is effectively used only when it is necessary to do the bandwidth estimate in case of the low traffic (b<B). The equation (10) caps the Tw growth in case of the small packet size.

Then the total theoretical connection bandwidth B is estimated by its approximate value Bappr, which is calculated as:

| | | | |
|---|---|---|---|
| (13) | Bappr = V0/Trtt(V), | if | V <= V0 |
| (14) | Bappr = V/Trtt(V), | if | V > V0 |

The full description of reasons that led to the introduction of Tw and Bappr in the form defined by (9-14) is pretty lengthy and is outside the scope of this document. However, it should be said that unfortunately it does not seem possible to have a precise estimate of B even when a delay is used. The error of Bappr when compared to B as defined by (5) depends on many factors. Shortly speaking, different forms of the functional relationship between Trtt and V (the form of the Trtt(V) function) can influence this error significantly. At the same time, it is very difficult to find the actual shape of the Trtt(V) function with any degree of accuracy under the real network conditions, and this function's shape can change faster than the statistical methods would find the reasonably precise shape of this function anyway.

So the equations (9-14) represent the result of the attempts to find a bandwidth estimate that would produce a reasonably precise value of Bappr in the wide range of the possible Trtt(V) function shapes. The analysis of different cases (different Trtt(V) function shapes, G-Nagle influence, etc) shows that if the Q-algorithm tries to bring the value of b to the rho*B level, the worst possible estimate of B using the equations (9-14) results in a convergence of b to:

b→rho*B/sqr(rho), (15)

which for the rho=0.5 suggested in [1] results in b actually converging to the level 0.707*B instead of 0.5*B when the request traffic is nonexistent (as in FIG. 3). Naturally, in the real network at least some request traffic would be present, bringing the actual total traffic closer to its theoretical limit B (as defined in (5)) and making the error even smaller. However, if this 40% increase in the response traffic happens to be a problem under some real network conditions because of the fractal character of the traffic and would cause the frequent response overflows, it is always possible to use smaller values of rho. For example,

| | | | |
|---|---|---|---|
| (16) | b −> 0.55*B, | if | rho = 0.3 |

even in the biggest possible error case.

Just to illustrate the equations (9-14) operation, let's have a look at the same shape of the Trtt(V) function as the one considered earlier: Trtt=V/B.

Then the equation (13) would give us the following bandwidth approximation:

Bappr=B*V0/V, (17)

and, the Q-algorithm would bring the response traffic rate to

b=0.5*Bappr=0.5*B*V0/V (if rho=0.5) (18)

The response stream with this rate would, in turn, result in the packets of size

V=b*(Trtt+Tw)=b*Trtt*V0/V (after we substitute Tw from (9)) (19)

Now, since Trtt=V/B, we arrive to

V=b*V0/B. (20)

Combining this with (18), we receive

Vˆ 2=0.5*V0ˆ 2, or V=V0/sqr(2), (21)

and,

b=0.5*B*sqr(2)=0.707*B (22)

First, this result verifies the correctness of substitution of equation (9) for Tw into (19) and the correctness of using the equation (13) as the basis for (17). And second, it shows that in that case the state of the equilibrium (constant V, b and Trtt) is achievable for the traffic and the response bandwidth error is exactly the one suggested by the equation (15). (This example uses a pretty ‘bad’ shape of the Trtt(V) function from the Bappr error standpoint—we could have analyzed many cases with the lower or even nonexistent Bappr error, but it is useful to have a look at the worst case).

Finally it should be noted that the equations (9-14) contain only the packet total size and roundtrip times and say nothing of whether the packet carries the responses, the requests or both. Even though we used the model situation of nonexistent request traffic (FIG. 3) to illustrate the necessity of this approach to the bandwidth estimate, the same equations should also be used in the general case, when the packet carries the traffic of both types. In fact, it can be shown that the error of the Bappr estimate approaches zero regardless of the Trtt(V) function shape when the total packet size V (responses and requests combined) approaches V0 (512 bytes).

### 7. Packet Layout and Bandwidth Sharing

The packet layout and the bandwidth sharing between the sub-streams are defined by the Fairness Block algorithms [1]. The Fairness Block goal is twofold:

To make sure that the outgoing connection bandwidth available as a result of the outgoing flow control algorithm operation is fairly distributed between the back-traffic (responses) intended for that connection and the forward-traffic (requests) from the other connections (the total output of their Q-algorithms).

To make sure that the part of the outgoing bandwidth available for the forward-traffic broadcasts from other connections is fairly distributed between these connections.

The first goal is achieved by ‘softly reserving’ some part of the outgoing connection bandwidth Gi for the back-traffic and the remainder of the bandwidth—for the forward-traffic. The bandwidth ‘softly reserved’ for the back-traffic is Bi and the bandwidth ‘softly reserved’ for the forward-traffic is Fi:

‘Softly reserved’ here means, for example, that when, for whatever reason, the corresponding stream does not use its part of the bandwidth, the other stream can use it, if its own sub-band is not enough for it to be fully sent out. But if the sum of the desired back- and forward-streams to be sent out exceeds Gi, each stream is guaranteed to receive at least the part of the total outgoing bandwidth Gi which is ‘softly reserved’ for it (Bi or Fi) regardless of the opposing stream bandwidth requirements. For brevity's sake, from now on, we will actually mean ‘softly reserved’ when we will apply the word ‘reserved’ to the bandwidth.

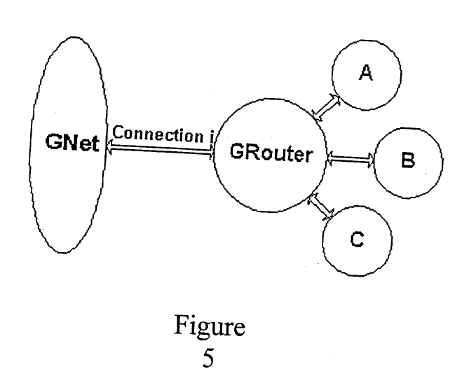

In FIG. 4, the current back-traffic bi is shown to be two times less than Bi, since Q-algorithm tries to keep the back-stream at that level; however, it can fluctuate and be much less than Bi if the requests do not generate a lot of back-traffic, or temporarily exceed Bi in case of the back-traffic burst. If bi<=Bi, the entire bandwidth above bi is available for the forward-traffic. If the desired back-traffic exceeds Bi, the actual back-traffic bi can be higher than Bi only if the desired forward-traffic from the other connections yi is less than Fi; otherwise, the back-traffic fully fills the Bi sub-band and the forward-traffic fully fills the Fi. So the actual forward-traffic stream foi is equal to the desired forward-traffic yi only if either yi<Fi, or yi+bi<Gi; otherwise, foi<yi and some forward-traffic (request) messages have to be dropped.

7.1. Simplified Bandwidth Layout.

The method calculates the bandwidth reserved for the back-traffic Bi in [1] (Eq. 24-26) essentially tries to achieve the convergence of the back-traffic bandwidth Bi to some optimal value:

<Bi>→<Gi−0.5*foi> (23)

This optimal value was chosen in such a way that it would protect the forward-traffic (requests from other connections) in case of the back-traffic (response) bursts—the bandwidth reserved for the forward-traffic (Fi=Gi−Bi) should be no less than half of the average forward traffic <foi> on the connection. Thus the back-traffic bursts cannot significantly decrease the bandwidth part used by the forward traffic or completely shut off the forward traffic data flow. Similarly, the back-traffic is protected from the forward-traffic bursts—from the equation (23) it is clear that Bi>=0.5*Gi, so at least half of the connection bandwidth is reserved for the back-traffic in any case.

However, in case of the finite message size, the equation (23) has one problem. Let us consider a ‘GNet leaf’ structure, consisting of a GRouter and a few neighbors, none of which are connected to anything besides the GRouter. Such a configuration is shown in FIG. 5:

Here ‘Connection i’ connects this ‘leaf’ structure to the rest of the GNet. We will be interested in the traffic passing through this connection from right to left—from the ‘leaf’ to the GNet. The GRouter Fairness Block controls this traffic. Such a configuration is typical for the various ‘GNet reflectors’, which act as an interface to the GNet for several servents, or for the GRouter working in a ‘pure router’ mode. Then the GRouter has no user interface and no search block of its own and just routes the traffic for another servent (or several servents). Typically that configuration would result in a very low volume of request data passing through this ‘Connection i’ from right to left, since the ‘leaf’ has just a few hosts.

Because of this, the equation (23) in the GRouter fairness block might bring the value of Bi very close to Gi for that connection. To be precise, the stable value of Fi would be:

Fi=0,5*<foi>, (24)

where <foi> is a very low average forward-traffic sending rate. In the continuous-traffic model Fi=const, since this low sending rate <foi> is represented by the fairly constant low-volume data stream. The equation (23) convergence time (defined by the Eq. 15 in [1]) is irrelevant in that case.

The atomic messages (requests) of the finite size change this situation dramatically. Then every request represents a traffic burst of the very high instant magnitude (mathematically, it can be described as the delta-function—the infinite-magnitude burst with the finite integral equal to the request size). The equation (23) will try to average the sending rate, but since it has a finite convergence (averaging) time, in case the average interval between finite-size requests is bigger than the convergence time, the plot of Fi versus time will look like this:

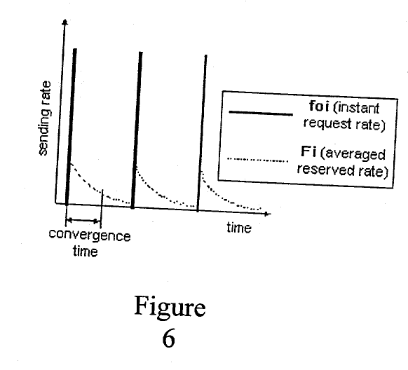

The plot in FIG. 6 makes it clear that if the average interval between requests is bigger than the equation (23) convergence time, the bandwidth Fi reserved for the requests can be arbitrarily small at the moment of the next request arrival. Since the equation (23) convergence time is not related to the request frequency (which might be determined by the users searching for files, for example), the small frequency of the requests leads to the small value of Fi when the request does arrive on the connection to be transmitted.

So when the request arrives, the bandwidth reserved for it might be very close to zero. If the back-traffic from the ‘leaf’ does not have a burst at that moment, it would occupy just about one half of the available bandwidth Gi, and the request transmission would not present any problem. But if the back-traffic experiences a burst, the bandwidth available for the request transmission would be just a very small reserved bandwidth Fi. Thus the time needed to transmit the finite-size request might be very large, even if the request would not be atomic. (In that case the start of the request transmission would gradually lower the Bi and this request transmission would take an amount of time comparable to the convergence time of the equation (23)).

However, since the request is atomic (unbreakable) and cannot be sent in small pieces between the responses on the same connection, the delay might be even bigger. In order to make sure that the sending operation does not exceed the reserved bandwidth, the sending algorithm has to ‘spread’ the request-sending operation over time, so that the resulting average bandwidth would not exceed a reserved value. Since from the sending code standpoint the request is sent instantly in any case, the ‘silence period’ of the Ts=Vr/Fi length would have to be observed after the request-sending operation in order to achieve that goal, where Vr is the request size. This ‘silence period’ can be arbitrarily long, because equation (23) decreases Fi in an exponential fashion as the time since the last request arrival keeps growing. If the next request to be sent arrives during this ‘silence period’ (which is quite likely when Ts grows to infinity), this new request either has to be kept in the fairness block buffers until the back-traffic burst ends, or to be just dropped.

Neither outcome is particularly attractive—on one hand, it is important to send all the requests, since the ‘Connection i’ is the only link between the ‘leaf’ and the rest of the GNet. And on the other hand, it is intuitively clear that the latency increase due to the new request being buffered for the rest of the ‘silence period’ is not necessary. After all, the request traffic from the ‘leaf’ is very low, and it would seem that sending all the requests without delays should not present any problem.

So the fairness block behavior seems be counterintuitive: if it is intuitively clear that the requests can be sent at once, why the equation (23) does not allow us to do that? To explain that, it should be remembered that the exponential averaging performed by the differential equation (23) (equation (26) in [1]) was designed to handle the continuous-traffic case. This averaging method assumes that the traffic being averaged consists of a very large number of very small and very frequent data chunks, which is clearly not the case in the example above. When the time interval between the requests exceeds the averaging (equation (23) convergence) time, these equations cease to perform the averaging function, which results in the negative effects that we could observe here.

Besides, the Fairness Block equations were designed to protect the average forward-traffic from the back-traffic bursts and other way around. These equations do nothing to protect the forward-traffic bursts, since it was assumed that it is enough to reserve the forward-traffic bandwidth that would be close to the average forward-traffic-sending rate. This approach really works when the forward-traffic messages (requests) are infinitely small. However, as the averaging functionality breaks down with the growth of the interval between requests, and each request is a traffic burst, nothing protects this request from the simultaneous burst in the back-traffic stream, resulting in the latency increase and possibly in the request loss.

Thus it is clear that the finite-message case presents a very serious problem for the Fairness Block, and something should be done to deal with the situations like the one presented above. In principle, it might be possible to extend the Fairness Block equations to handle the case of the ‘delta-function-type’ (non-continuous) traffic. However, such an approach is likely to be complicated, so here we suggest a radically different solution.

Let us make both reserved sub-bands (Bi and Fi) fixed:

Fi=Gi/3, (25)

Bi=2*Gi/3 (26)

and compare the resulting bandwidth layout with the ‘ideal’ layout in an assumption that such a layout really does exist and can be found.

The solution presented in (25,26) is not an ideal one—it does not take into consideration the different network situations, different relationships between the forward- and backward-traffic rates and so on. Thus it is expected that in some cases such a bandwidth layout would result in a smaller connection traffic than the ‘ideal’ layout, effectively limiting the ‘request reach’: the servents would be able to reach fewer other servents with their requests and would receive less responses in return.

Let's check the maximal theoretical throughput loss for the back- and forward-traffic streams in case of the fixed bandwidth layout (25,26).

The biggest possible average back-traffic is

<bimax>=0.5*<Gi>, (27)

and the average fixed-bandwidth traffic is

<bi>=0.5*Bi=Gi/3. (28)

Thus the worst theoretical response throughput loss is about 33%. However, the fixed bandwidth layout is going to be used together with the bandwidth estimate algorithm described in section 6.2 of this document. That algorithm is capable of increasing the back-traffic by a factor of 0.707 (Eq. (15) with rho=0.5) in some cases, so these errors might even cancel each other, possibly resulting in an average back-traffic <bi>˜0.47*Gi, which is pretty close to an ideal value.

The biggest possible average forward-traffic is

<foimax>=<Gi>. (29)

In case of the fixed bandwidth the average forward traffic is limited by the average back-traffic (<foi><=<Gi−bi>). However, since the average back-traffic should not take more than ⅓ of the whole bandwidth (Eq. (28)), then

<foi>>=2*<Gi>/3, (30)

which represents a 33% theoretical request throughput loss.

At the first glance, one might expect that in the very worst case (back-traffic errors cancel and <bi>=0.47*<Gi>), the average forward-traffic would be limited by the expression <foi>=0.53*<Gi>, meaning that a 47% request throughput loss is possible. However, for the equation (15) to be applicable, the total traffic bi+foi has to be less than Gi. But if this is the case, there are not enough requests to fill the full available bandwidth (Gi−bi) anyway. So then the fixed bandwidth layout approach does not limit the request stream-sending rate and as far as the forward stream is concerned, there are no disadvantages introduced by the fixed bandwidth layout at all.

Thus the worst possible throughput loss for both back- and forward-traffic is about 33% versus the ‘ideal’ bandwidth-sharing algorithm, assuming that such an algorithm exists and can be implemented. This throughput loss is not very big and is fully justified by the simplicity of the fixed bandwidth sharing. It is also important to remember that this number represents the worst throughput loss—in real life the forward-traffic throughput loss might be less if the response volume is low. Then bi<Bi/2 and the bandwidth available to the forward-traffic is going to be bigger. All these considerations make the fixed bandwidth sharing as defined by (25,26) the recommended method of bandwidth sharing between the request and response sub-streams.

7.2. Packet Layout.

In practice the value of Gi can fluctuate with each packet and is not known before the packet is actually sent, making the values of Bi and Fi also hard to predict. This makes it very difficult to fulfill the bandwidth reservation requirements (25,26) directly, in terms of the data-sending rate. The relationship between the bandwidths of the forward- and back-streams has to be maintained indirectly, by varying the amount of the corresponding sub-stream data placed into the packet to be sent. Naturally, the presence of the finite-size atomic messages complicates this process further, making the precise back- and forward-data ratio in the packet hard to achieve.

Let us start with a simpler task and imagine that the traffic can be treated as a sequence of the arbitrarily small pieces of data and see how the bandwidth sharing requirements (25,26) would look in terms of the packet layout.

The packet to send is assembled from the continuous-space data buffers (Hop-layered request buffers and a Response buffer in FIG. 2) when the packet-sending requirements established in section 6.2 have been fulfilled. To simplify the task even more, let's imagine that we have a single request buffer, so the packet is filled by the data from just two buffers—the request and the response one.

If the summary amount of data in both buffers does not exceed the full packet size V0 (512 bytes). The packet-filling procedure is trivial—both buffers' contents are fully transferred into the packet, and the resulting packet is sent, leaving us with empty request and response buffers. In terms of the bandwidth usage, it corresponds to the case of the bandwidth non-overflow, and in case the total amount of data sent is even less than 512 bytes, the equations (9-11) show that an additional wait time is required before sending such a packet. Which means that the bandwidth is not fully utilized—we could increase the sending rate by bringing the waiting time Tw to zero and filling the packet to its capacity, if we'd have more data in request and response buffers.

Looking at the bandwidth reservation diagram in FIG. 4, we see that in such a case (bi+foi<=Gi) the bandwidth reservation limits Bi and Fi are irrelevant. These are the ‘soft’ limits and have to be used only if the sum of the desired back- and forward-traffic sending rates bi and yi exceeds the full bandwidth Gi.

Of course, even though Bi is not used to limit the traffic, it still has to be communicated to the Q-algorithm of that connection so that it could control the amount of request data it passes further to be broadcast. In order to find the Bi, the total channel bandwidth Gi has to be approximated by the Bappr found from (13). Then the Bi estimate is found from (26) as

Bi=2*Bappr/3=2/3*V0/Trtt. (31)

Naturally, this can be done only postfactum, after the packet is sent and its PONG echo is received from the peer, but that does not matter—the Q-algorithm equations [1] are specifically designed to be tolerant to the delayed and/or noisy input.

Now let's consider the case when the summary amount of data in the request and the response buffers exceeds the desired packet size V0 (512 bytes). Since we are still working in the continuous-traffic model, it is clear that the packet size should be exactly V0 and the wait time Tw should be zeroed. And now we face a question—how much data from each buffer should be placed into the packet in order to make the packet of exactly V0 size and satisfy the bandwidth reservation requirement (25,26)?

Let us designate the amount of forward (request) data in the packet as Vf and the amount of back-data (responses) as Vb. Obviously,

Vf+Vb=V0. (32)

After the packet PONG echo returns and the total bandwidth Gi estimate Bappr is calculated from (14), it will be possible to find the value of Bi from (31) as

Bi=2/3*V0/Trtt, (33)

and the value of Fi as

Fi=Bappr/3=1/3*V0/Trtt. (34)

At the same time (after the PONG echo is received) it will be possible to find the sending rates of the forward- and back-traffic as

foi=Vf/Trtt and (35)

and

bi=Vb/Trtt, (36)

after which we would be able to see whether the values of foi and bi exceed the reserved bandwidth values Fi and Bi or not. However, that would be too late—we need this answer before we send the packet in order to determine the desired values of Vf and Vb for it. Fortunately, even before we send the packet, from (34) and (35) it is clear that

foi/Fi=3*Vf/V0, (37)

and from (33) and (36)

bi/Bi=3/2*Vb/V0, (38)

which means that if bi=Bi and foi=Fi, then

Vf=V0/3 (39)

Vb=2*V0/3 (40)

So using (39,40) we can determine whether the bandwidth reservation requirements (25,26) will be satisfied even before we send the packet. It should be remembered, though, that the bandwidth reservation requirements (25,26) are ‘soft’. That is, we can have Vf or Vb exceeding the value defined by (39) or (40), provided that the opposite stream can be fully sent (the amount of data in its FIG. 2 buffer is less than the value defined by the equation (40) or (39), correspondingly). First, we try to put Vf and Vb bytes of requests and responses into the packet. If some buffer does not have enough data to fully fill its Vx packet part, then the data from the opposite buffer can be used to pad the packet to V0 size, provided that there's enough data available in this opposite buffer.

Then, after the packet is sent and its PONG OFC echo returns, we should calculate the actual value of Bi for the Q-algorithm, using the same equation (31) that we use for the packet with size V<V0.

Now that we have the bandwidth reservation requirements (25,26) translated into the packet volume terms (39,40), we can abandon the continuous-traffic assumption and consider the case of the finite-size atomic messages.

In this case the request and the response buffers contain the finite-size messages, which can be either fully placed into the packet, or left in the buffer (for now, we'll continue assuming that there's just one request buffer—the multiple-buffer case will be considered later). The buffers are already prioritized according to the request hop (in case of the hop-layered request buffer) or according to the summary response volume (in case of the response buffer). Thus the packet to be sent might contain several messages from the request buffer head and several messages from the response buffer head (either number can be zero).

Here the ‘packet’ means a sequence of bytes between two OFC PINGs—the actual TCP/IP packet size might be different if the algorithm presented in section 6.1 (equations (2-4)) splits a single OFC packet into several TCP/IP ones. Again, we can have two situations—when the summary amount of data in both buffers does not exceed the packet size V0 (512 bytes) and when it does.

If both buffers can be fully placed into the packet, there are no differences between this situation and the continuous-traffic space case at all. Since we are fully sending all the available data in one packet, it does not matter whether it is a set of finite-size messages or a continuous-space volume of data—we are not breaking the data into any pieces anyway. So we can just apply the continuous-traffic case reasoning and, as a final step, calculate the Bi for the Q-algorithm using (31).

If, however, the summary amount of data in request and response buffers exceeds V0 and the messages are atomic and have the finite size, typically it would be impossible to achieve the precise forward- and backward-data size values in the packet as defined by (39,40). Thus we have to use the approximate values for the Vf and Vb, so that in the long run (when many packets are sent) the resulting data volume would converge to the desired request/response ratio:

| | | | |
|---|---|---|---|
| (41) | Sum(Vb)/Sum(Vf) −> 2, | as | Sum(Vb), Sum(Vf) −> infinity. |

In order to achieve that goal, the ‘herringbone stair’ algorithm is introduced:

7.3. ‘Herringbone Stair’ Algorithm.

This algorithm defines a way to assemble the sequence of packets from the atomic finite-size messages so that in the long run the volume ratio of request and response data sent on the connection would converge to the ratio defined by (41). Naturally, the algorithm is designed to deal with the situation when the sum of the desired request and response sub-streams exceeds the connection outgoing bandwidth Gi, but it should provide a mechanism to fill the packet even when this is not the case.

In order to do that, an accumulator variable acc with an initial value of zero is associated with a connection. At any moment when we need to place another message into the packet, we choose between two candidates (the first messages in the request and response buffers) in a following way:

For both messages the ‘probe’ accumulator values (accF for forward-traffic and accB for back-traffic) are calculated:

accB=acc−Sb, (42)

and

accF=acc+2*Sf, (43)

where Sb and Sf are the sizes of the first messages in the corresponding (response and request) buffers. Then the values of abs(accB) and abs(accF) are compared, and the accumulator with the smaller absolute value wins, replaces the old acc value with its accX value, and puts the message of type ‘X’ into the packet. This process is repeated until the packet is filled. If at any moment when the choice has to be made, at least one of the buffers is empty and the accB or accF value cannot be calculated, the message from the buffer, which still has the data (if any), is placed into the packet. At the same time the acc variable is set to zero, effectively ‘erasing’ the previous accumulated data misbalance.

The packet is considered ready to be sent according to the algorithm presented in section 6.1 (equations (2-4)). At that point we exit the packet-filling loop but remember the latest accumulator value acc—we'll start to fill the next packet from this accumulator value, thus achieving the convergence requirement (41).

Graphically this process can be represented by the picture, which looks like this:

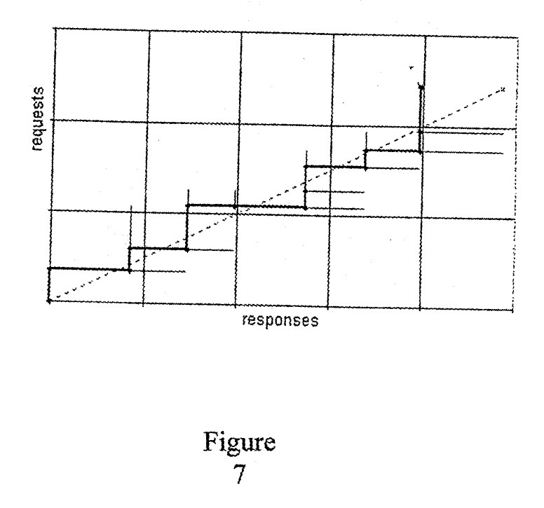

The chart in FIG. 7 illustrates the case when both the request and the response buffers have enough messages, so the accumulator does not have to be zeroed, ‘dropping’ the plot onto the ‘ideal’, ½-tangent line. (This dashed line represents the packet-filling procedure in case of the continuous-space data, when the traffic can be treated as a sequence of the infinitely small chunks). The horizontal thick lines represent the responses, and the line length between markers is proportional to the response message size. Similarly the vertical thick lines represent the requests. The thin lines leading nowhere correspond to the hypothetical, ‘probe’ accX values, which have lost against the opposite-direction step, since the opposite-direction accumulator absolute value happened to be smaller. Thus every step along the chart in FIG. 7 (moving in the upper right direction) represents the step that was closest to an ‘ideal’ line with a tangent value of 1/2.

This algorithm has been called the ‘herringbone stair algorithm’ for an obvious reason—the bigger (losing) accX value probes (thin lines leading nowhere) resemble the pattern left on the snow when one climbs the hill during the cross-country skiing.

So the basic algorithm operation is quite simple. One fine point, which has not been discussed so far, is the fate of the rest of the data in the request or the response buffer after the packet is sent and it could not accept all the data from the corresponding buffer.

In case of the response buffer the situation is clear: the flow control algorithms try not to drop any responses unless absolutely necessary. That is, unless the response storage delay reaches an unacceptable value (see section 4 for the more detailed explanation of what the ‘unacceptable delay value’ is). If the time spent by the response in buffer does reach an unacceptable timeout limit, the response buffer timeout handler drops such a response, but this is done in a fashion transparent to the packet-filling algorithms described here. No other special actions are required.

The situation with the request buffer is a bit different. This hop-layered buffer was specifically designed to handle a situation when just a small percentage of the requests in this buffer can be sent on the outgoing connection. The idea was that when the GNet has relatively low response traffic and the Q-algorithm passes all the incoming requests to the hop-layered request buffer, since there's no danger of the response overflow, then the GNet scalability is achieved by the RR-algorithm and an OFC block. This block sends only the low-hop requests out, dropping all the rest and effectively limiting the ‘request reach’ radius regardless of its TTL value and minimizing the connection latency when the GNet is overloaded.

Since on the average, all incoming and outgoing connections carry the same volume of the request traffic, in this situation (when the RR-algorithm and OFC block take care of the GNet scalability issues) the average percentage of the dropped requests (taken over the whole GNet) is about

Pdrop=(N−1)/N, (44)

where N is the average number of the GRouter connections. So with N=5 links, it can be expected that on the average just about 20% of the requests in the hop-layered request buffer would be sent out and 80% would be dropped.

In case of the continuous-space traffic, we can just clear the request buffer immediately after the packet is sent. This would bring the worst-case request delay on the GRouter to its minimal value, equal to the interval between the packet-sending operations. Unfortunately this is not always possible in the finite-size message case. The reason for this is that when the requests are infinitely small, we can expect the following request buffer layout when we are ready to begin assembling the outgoing packet:

Here the buffer contains a very large number of the very small requests, and statistically the requests with every possible hop value would be present. So every time the packet is sent, it would contain all the data with low hops and would not include the buffer tail—the requests with a biggest hop value would be dropped. What is important here is that from the statistical standpoint, it is a virtual certainty that all the requests with very low hop values (0,1,2, . . . ) are going to be sent.

To appreciate the importance of that fact, let us consider the ‘GNet leaf’ presented in FIG. 5. The ‘leaf’ servents A, B, C can reach the GNet only through the GRouter. When these servents' requests traverse the ‘Connection i’ link, they have a hop value of 1. So if the GRouter has the significant probability of dropping the hop=1 requests, it is likely that these servents might never receive any responses from the GNet just because the requests would never reach the GNet in the first place. By the same token, if the GRouter's peer in the GNet (the host on the other side of the ‘Connection i’) is likely to drop the hop=2 requests, the total response volume arriving back to A, B, C will be decreased. Even if the hosts A, B, C would have other connections to GNet aside from the one to the GRouter, it would still be important to broadcast their requests on the ‘Connection i’. Generally speaking, the less is the request hop value, the more important it is to broadcast such a request.

As we move to the finite message size case, we immediately notice two differences: first, the number (though not the total size) of the requests in the hop-layered buffer decreases and the statistical rules might no longer apply. For example, as we start to fill the packet, we might have no requests with hop 0, one request with hop 1, two requests with hop 4 and one request with hop 7. This fact will be important later on, as we move to the multi-source herringbone stair algorithm with several request buffers.

The second difference, which is more important for us here, is that the OFC algorithm might choose to send the packet containing only the responses. Let's have another look at FIG. 7 and imagine ourselves that all the messages there (the thick lines between the markers) are bigger than V0 (512 bytes). Then every such message will be sent as a single OFC packet (and maybe multiple TCP/IP packets), which would consist of this big message (request or response) followed by an OFC PING. Essentially, every marker in the FIG. 7 will correspond to the OFC packet sending operation.

Then, if we would clear the request buffer as soon as the response OFC packet is sent, the requests that have arrived since the last packet-sending operation would be dropped and would halve precisely zero chance of being sent regardless of their importance in terms of the hop value. In fact, the herringbone stair algorithm can send several ‘response-only’ packets in a row (see the third ‘step’ in FIG. 7—it contains two responses), making it even more probable that the ‘important’ low-hop request would be lost.

This is why it is important to clear the request buffer only after at least a single request is placed into the packet. The graphical illustration of such an approach is presented in FIG. 9:

This is essentially the plot from the FIG. 7, but with ellipses marking the time intervals during which the incoming requests are just added to the request buffer and nothing is removed from it. The chart assumptions are that first, every message is sent in a single OFC packet, and second, that the physical time associated with the plot marker is the moment when the decision is made to include the message, which begins at the marker, into the packet to be sent. That is, the very first marker (at the lower left plot corner) is when the decision is done to send the first message—the request that is plotted as a vertical line on the chart. The small circle surrounding that first marker means that at this point we can clear the request buffer, removing all the other requests from it.

Then we send a response (a horizontal line), but do not clear the request buffer, since we would risk losing the important requests that could arrive there in the meantime. The request buffer is cleared again only after the herringbone stair algorithm decides to send a request and places this request into the packet (the beginning of the second vertical line). Then the request buffer can be reset again, and the ellipse, which covers the whole first ‘step’ of the ‘stair’ in the plot, shows the period during which the incoming requests were being accumulated in the request buffer. At the end of the horizontal line (when the new packet can be sent), all the requests accumulated during the time covered by the ellipse start competing for the place in the packet, and the process goes on with the request accumulation periods represented by the ellipses on the chart.

Note that the big ellipse that covers the third ‘step’ of the ‘stair’ is essentially a result of the big third request being sent. If the packet roundtrip time is proportional to the packet size, this ellipse might introduce a significant latency into the request-broadcasting process—the next request to be sent might spend a long time in the buffer. Unless the GNet protocol is changed to allow the non-atomic message sending, such situations cannot be fully avoided. On one hand, the third request was obviously important enough to be included into the packet, and on the other hand, the bandwidth reservation requirements do not allow us to decrease the average bandwidth allocated for the responses, and to send the next request sooner. But at least the ‘herringbone stair’ and the request buffer clearing algorithms make sure that the important low-hop requests have the fair high chance to be sent within the latency limits defined by the current bandwidth constraints.

Since the finite-size messages can lead to the OFC packets with size exceeding V0 (512 bytes), it might be that we'll have to use equation (14) instead of (13) to evaluate the bandwidth Bi if V>V0. So instead of equation (31) for Bi (as it was the case for the continuous-space traffic), the ‘herringbone stair’ algorithm uses the following equations to evaluate the bandwidth Bi reserved for the back-traffic:

| | | | |
|---|---|---|---|
| (45) | Bi = 2/3 * V0/Trtt, | if | V <= V0, and |
| (46) | Bi = 2/3 * V/Trtt, | if | V > V0, |

where V is the OFC packet size produced by the ‘herringbone stair’ algorithm.

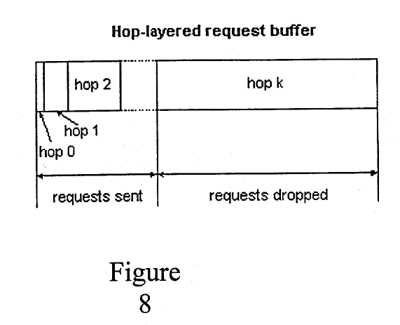

Finally, it should be noted that even when the request buffer clearing algorithm does allow us to remove all the requests from the buffer, this operation should not be performed unless the reset timeout Tr time (˜200 ms) has passed since the last buffer-clearing operation. This timeout is logically similar to the G-Nagle algorithm timeout introduced previously—its goal is to handle the case when the big packets are sent very frequently on the low-roundtrip-time links. Then the fact that the requests are kept in buffer for 200 ms does not noticeably increase the response latency, but might improve the request buffer layout from the statistical standpoint, bringing it closer to the continuous-space layout presented in FIG. 8.

Now that we have fully described the ‘herringbone stair’ algorithm in case of the single request buffer, we can move to the effects introduced by the presence of the multiple GRouter connections and hop-layered request buffers.

7.4. Multi-Source ‘Herringbone Stair’.

When the GRouter connection has multiple request buffers (that is, the GRouter has more than two connections), the basic principles of the packet-filling operations remain the same. The bandwidth still has to be shared between the requests and the responses, the ‘herringbone stair’ algorithm still plots the ‘stair’ pattern if there's not enough bandwidth to send all the data—the difference is that now the requests have to be taken from several buffers. This is the job of the hop-layered round-robin algorithm introduced in [1] (‘RR-algorithm’ block in FIG. 2.)

The RR-algorithm essentially prioritizes the ‘head’ (highest priority, low-hop) requests from several buffers, presenting a ‘herringbone stair’ algorithm with a single ‘best’ request to be compared against the response. The reasoning behind the round-robin algorithm design was described in [1]; here we just provide a description of its operational principles with an emphasis on the finite request size case.

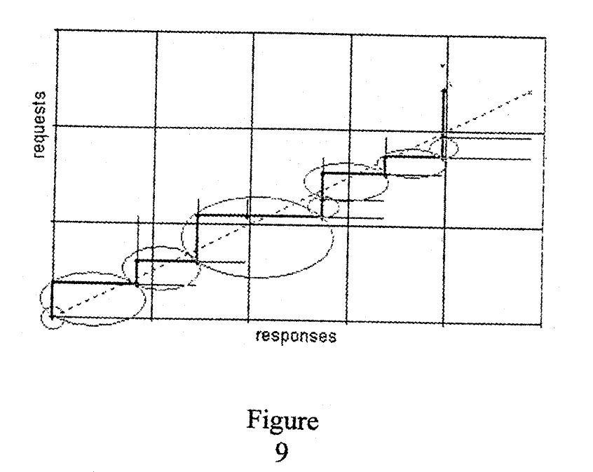

The hop-layered round-robin algorithm operation is illustrated by FIG. 10:

The algorithm queries all the hop-layered connection buffers in a round-robin fashion and passes the requests to the ‘herringbone stair’ algorithm. Two issues are important:

No responses with the high hop values are passed until all the requests with the lower hop values are fully transferred from all the request buffers. If some request buffer has just the high-hop requests, it is just skipped by the round-robin algorithm in the meantime.

Within one hop layer, the RR-algorithm tries to transfer roughly the same amount of data from all buffers that have the requests with the hop value that is being currently processed. In order to achieve that, every buffer has a hop data counter hopDataCount associated with it. This counter is equal to the number of bytes in the requests with the current hop value that have been passed to the herringbone stair algorithm from that buffer during the packet-filling operation that is currently underway. Every time the RR-algorithm fully transfers all the current-hop requests from the buffers, all the counters are reset to zero and the process continues from the next buffer (round-robin sequence is not reset).

The current maximal and minimal hopDataCount values for all buffers maxHopDataCount and minHopDataCount are maintained by the RR-algorithm. The request is transferred from the buffer by the RR-algorithm only if this buffer's hopDataCount satisfies the following condition:

hopDataCount<maxHopDataCount OR hopDataCount=minHopDataCount. (47)

If this condition is not fulfilled, the buffer is just skipped and the RR-algorithm moves on to the next buffer. This prevents the buffers with large requests from monopolizing the outgoing request traffic sub-band, which would be possible if the requests would be transferred from buffers in a strictly round-robin fashion.

When the RR-algorithm is used (that is, there is more than one request buffer), the herringbone stair algorithm has to make a choice as to when it should clear all the requests from these several request buffers.

This decision is influenced by pretty much the same considerations as the similar decision in case of the single request buffer (which is described in section 7.3):

The request buffer should not be cleared before the whole OFC packet is assembled.

The request buffer should not be cleared more than once per Tr (˜200-ms) time interval.

The request buffer should not be cleared in such a way that all the requests in it would be dropped before at least one of them is sent—every request must have a chance to compete for the slot in the outgoing packet with the requests from the same buffer.

So the buffer-clearing algorithm presented in section 7.3 is extended for the multiple-buffer situation. The decision to reset the buffers' contents is done for each buffer individually and the buffer can be cleared no sooner than some request from this buffer is included into the outgoing packet by the ‘herringbone stair’ algorithm.

Of course, this approach might increase the interval between the buffer resets. For example, if some buffer contains a just a single high-hop request, this request can spend a lot of time in the buffer—until some low-hop request arrives there, or until no other buffer would contain the requests with lower hop values. But this is not a big problem—we are mainly concerned with the low-hop requests' latency, since these are the requests, which are typically passed through by the RR- and ‘herringbone stair’ algorithms. Even if this high-hop request spends a lot of time in its request buffer before being sent, in practice that would most probably mean that multiple other copies of this request would travel along the other GNet routes with little delay. So the delayed responses to that request copy would make just a small percentage of all responses (even if such a request is not dropped), having little effect on the average response latency.

### 8. Q-Algorithm Implementation

The Q-algorithm [1] goal is to make sure that the response flow would not overload the connection outgoing bandwidth, so it limits the request broadcast to achieve this goal, if necessary. Now let us consider the effects that the messages of the finite size are going to have on the Q-algorithm. We are going to have a look at two separate and unrelated issues: Q-algorithm latency and response/request ratio calculations.

8.1. Q-Algorithm Latency.

The Q-algorithm output is defined by the equation (1) or (52) (Eq. (13) in [1]). This equation essentially defines the percentage of the forward-traffic (requests) to be passed further by the Q-algorithm to be broadcast. When the requests have the finite size, the continuous-space Q-algorithm output x has to be approximated by the discrete request-passing and request-dropping decisions in order to achieve the same averaged broadcast rate. When the full broadcast is expected to result in the response traffic that would be too high for the connection to handle, only the low-hop requests are supposed to be broadcast by the Q-algorithm. The high-hop requests are to be dropped. Essentially, the Q-algorithm is responsible for the GNet flow control and scalability issues when the response traffic is high—pretty much as the RR-algorithm and the OFC block are responsible for the GNet scalability when the response traffic is low.

This task is similar to the one performed by the OFC block algorithms described in section 7, which achieve the averaging goal (41) for the packet layout. So the similar algorithms could achieve the Q-algorithm averaging goals. However, it is easy to see that the algorithms described in section 7 require some buffering—in order to compare the different-hop requests, the hop-layered request buffers were introduced, and these buffers are being reset only after certain conditions are satisfied. These buffers necessarily introduce some additional latency into the GRouter data flow, and an attempt to utilize similar algorithms to achieve the Q-algorithm output averaging would also result in the additional data transfer latency for the GRouter.

Thus a different approach is suggested here. Since the fairness block algorithms already use the request buffers, it makes sense to utilize these same buffers to control the request broadcast rate according to the Q-algorithm output. This is possible since both OFC block and Q-algorithm use the same ‘hop value’ criteria to determine which requests are to be sent out and which are to be dropped. So if the ‘Q-block’ is added to the RR-algorithm, such a combined algorithm can use the same buffers to achieve the finite-message averaging for both OFC block and Q-algorithm at once. Then the Q-algorithm does not add any additional latency to the GRouter data flow, and its output just controls the Q-block of the RR-algorithm that performs the request rating, comparison and data flow averaging for both purposes.

In order to achieve that, every request arriving to the Q-algorithm is passed to the Request broadcaster (FIG. 2)—no requests are dropped by the Q-algorithm itself. However, before the request is passed to the Request broadcaster, it is assigned a ‘desired number of bytes’ (desiredBroadcastBytes) value. This is the floating-point number that tells how many bytes out of this request's actual size the Q-algorithm would want to broadcast, if it would be possible to broadcast just a part of the request. Naturally, desiredBroadcastBytes cannot be higher than the request size (since the Q-algorithm output is limited by 100% of the incoming request traffic).

After that all the request copies are placed into the hop-layered request buffers of the other connections, so that their desiredBroadcastBytes values can be analyzed by the Q-blocks of the RR-algorithms on these connections. The Q-block starts to work when the packet assembly is being started. It goes through the request buffers and calculates the ‘Q-volume’ for every buffer—the amount of buffer data that the Q-algorithm would want to see sent out.

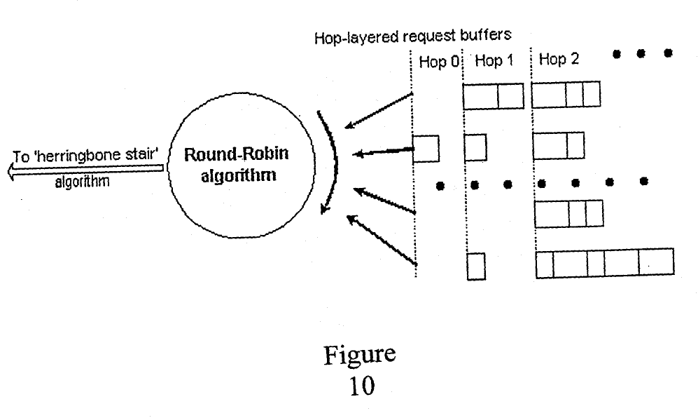

The RR-algorithm and the Q-block maintain the buffer Q-volume value in a cooperative fashion. The initial buffer Q-volume value is zero. When the new request is added to the buffer, the Q-block adds the request desiredBroadcastBytes value to the buffer's Q-volume. After the request buffer is sorted according to the hop-values of the requests, only the requests that are fully within the Q-volume part of the buffer are available for the RR-algorithm to be placed into the packet or to be dropped when RR-algorithm clears the request buffer. This buffer layout can be illustrated by the FIG. 11:

Only the requests that fully fit within the Q-volume have a chance to be sent out (are available to the RR-algorithm). When the request is removed from the buffer by the RR-algorithm, the buffer's Q-volume is decreased by the full size of this request. Similarly, when the multi-source herringbone stair algorithm clears the request buffer contents, it clears all the requests available to the RR-algorithm, decreasing the buffer's Q-volume correspondingly.

Thus after the RR-algorithm resets the request buffer, the requests available to the RR-algorithm (the gray ones in FIG. 11) are going to be removed from the buffer. The resulting buffer Q-volume value will be the difference between the original Q-volume value and the size of the buffer available to the RR-algorithm:

Qcredit=Qvolume−bufferSizeForRR. (48)

This remaining Q-volume value is called ‘Q-credit’, since it is used as the starting point for the Q-volume calculation when the Q-block of the RR-algorithm is invoked for the next time. It allows us to ‘average’ the discrete message-passing decisions, approximating the continuous-space Q-algorithm output over time.

Theoretically, the requests left in buffer after the RR-algorithm clears the requests available to it, (the white ones in FIG. 11) could be left in buffer and have a chance to be sent later. For example, if the first ‘white’ request in FIG. 11 (the one that has the Q-volume boundary on it) has a relatively low hop value, it could be sent out in the next OFC packet if the newly arriving requests would have the higher hop values.

In practice, however, this would result in the increased GRouter latency—such requests would spend more time in the buffer than the interval between the request buffer clearing operations. Since this is something we were trying to avoid in the first place, these requests are removed from the buffer, too—the GRouter latency minimization is considered to be more important than the better statistical layout of the data sent by the GRouter. So since we assume that the buffering requirements (intervals between buffer resets) defined by the multi-source herringbone stair algorithm (section 7.4) are enough for our purposes, we remove these requests as the buffer is cleared, too. When these requests are removed, the buffer Q-volume is not changed, so after the buffer is cleared we have an empty buffer with a Q-volume defined by the equation (48).

The Q-credit value is on the same order of magnitude as the average message size. In fact, if the Q-credit is large, the buffer Q-volume can be bigger than the whole buffer size. This does not change anything—the difference between the Q-volume and the buffer size available to RR-algorithm is still carried as the Q-credit to the next Q-block pass.

Which brings us to an interesting possibility. Let's say the very large-size request leaves a large Q-credit after the buffer is cleared, and at the same time the average request size becomes small and the incoming request traffic f drops significantly—for example, this can happen when the large-message DoS attack has stopped. Then, regardless of the current Q-algorithm output, it can take us a while until we throttle down the sending operations since we are going to fully send the amount of data equal to this Q-credit value first, and act according to the Q-algorithm output (x/f value) only after that.

In order to avoid that, the Q-credit left after the buffer reset is exponentially decreased over time with the characteristic time tauAv equal to the characteristic time (56) (Eq. (15), [1]) of the Q-algorithm that supplies the data to this request buffer:

dQcredit/dt=−(1/tauAv)*Qcredit. (49)

This guarantees that regardless of the instant Q-credit size due to an abnormally large request, its value will drop to ‘normal’ in a time comparable to the Q-algorithm characteristic time, so that the Q-algorithm would retain its traffic-controlling properties.

8.2. Response/Request Ratio and Delay.

Q-algorithm [1] can be presented as the following set of equations:

dQ/dt=−(beta/tauAv)*(Q−rho*B−u), Q<=Bav. (50)

u=max(0, Q−f*Rav) (51)

x=(Q−u)/Rav=min(f*Rav, Q)/Rav=min(f, Q/Rav) (52)

dRav/dt=−(beta/tauAv)*(Rav−R) (53)

dbAv/dt=−(beta/tauAv)*(bAv−b) (54)

dBav/dt=−(beta/tauAv)*(Bav−B) (55)

tauAv=max(tauRtt, tauMax), (where tauMax=100 sec) if bAv<=Bav and tauAv=tauRtt if bAv>Bav. (56)

Here the variables are:

x—the rate of the incoming forward-traffic (requests) passed by the Q-algorithm to be broadcast on other connections. Essentially, this variable is the Q-algorithm output.

B—the link bandwidth reserved for the back-traffic (responses). This variable is equivalent to Bi in terms of RR-algorithm and OFC block (section 7).

rho—the part of the bandwidth B to be occupied by the average back-traffic (rho=1/2).

beta=1.0—the negative feedback coefficient.

b—the actual back-traffic rate. This is the rate with which the responses to the requests x arrive from other connections. The outgoing response sending rate bi on the connection (section 7) can be lower than b, if b>B and the desired forward-traffic yi is greater than the bandwidth reserved for the forward-traffic Fi (see FIG. 4).

tauAv—the Q-algorithm convergence time.

Q—the Q-factor, which is the measure of the projected back-traffic. It is essentially the prediction of the back-traffic. The algorithm is called the ‘Q-algorithm’ because it controls the Q-factor for the connection. Q is limited with <B> to avoid the infinite growth of Q when <f*Rav><<rho*B> and to avoid the back-stream bandwidth overflow (to maintain x*Rav<=B) in case of the forward-traffic bursts.

f—the actual incoming rate of the forward traffic.

Rav—the estimated back-to-forward ratio; on the average, every byte of the requests passed through the Q-algorithm to be broadcast eventually results in Rav bytes of the back-traffic on that connection. This estimate is an exponentially averaged (with the same characteristic time tauAv) ratio R of actual requests and responses observed on the connection (see (53)).

R—the instant back-to-forward ratio; this is the ratio of actual requests and responses observed on the connection.

tauRtt—the instant value of the response delay. This is a measure of the time that it takes for the responses to arrive for the request that is broadcast by the Q-algorithm.

Bav—the exponentially averaged value of the back-traffic link bandwidth B. (Bav=<B>)

bAv—the exponentially averaged back-traffic (response) rate b. (bAv=<b>)

u—the estimated underload factor. When u>0, even if the Q-algorithm passes all the incoming forward traffic to be broadcast, it is expected that the desired part of the back-traffic bandwidth (rho*B) won't be filled. It is introduced into the equation to limit the infinite growth of the variable x and ensure that x<=f in that case.

The variables Q, u, x, Rav, Bav, bAv and tauAv are found from the equations (50-56), and the variables B, b, f, R and tauRtt are supplied as an input.

Furthermore, since equations (50) and (53-55) are the differential equations for the variables Q, Rav, bAv and Bav correspondingly, the system (50-56) requires the initial values for these variables. These initial values are set to zero as the calculations start. As a result, formally speaking, the equation (52) has the zero value for the Rav in the denominator on the first steps, which makes the computation of (52) impossible. In order to resolve that issue, let us notice that as the calculations are started at time t=0, the functions Q(t) and Rav(t) are going to grow as

Q(t)=(1/tauAv)*(rho*B(t)+u(t))*t (57)

and

Rav(t)=(1/tauAv)*R(t)*t (58)

correspondingly when the value of t is small enough (t→0).

Since from (51) and (57) it is easy to see that u(t)˜O(t), we can disregard the small u(t) in (57), which makes it clear that when t is small, the equation (52) can be written as

x(t)=min(f, rho*B(t)/R(t)). (59)

If t is so small that t<<tauRtt, the instant back-to-forward ratio R(t) represents just a small share of all responses for the requests issued since t=0—all responses will take about tauRtt time to arrive. So R(t)−>0 as t→0. On the other hand, B(t) is related to the channel bandwidth and is not infinitely small when t→0. Thus the second component in the equation (59) becomes infinitely large as t→0, which makes it possible to write (59) and (52) as

x=f, if Rav=0. (60)

That equation allows us to fully calculate the Q-algorithm output when we just start the calculations and Rav still has its initial value of Rav=0. Simply speaking, that means that when we have not seen any responses yet, we should filly broadcast all the incoming requests f, since we have no way to estimate the response traffic resulting from these requests.

Now let's have a look at the Q-algorithm input variables B, b, f, R and tauRtt.

The back-traffic bandwidth B (B=Bi, where Bi is defined in Section 7) is supplied to the Q-algorithm by the RR-algorithm and OFC block (see sections 6-7, Eq. (13,14), (3 1) and (45,46)).

The instant traffic rates b and f are directly observable on the connection and can be easily measured. Note that the request traffic rate f is the rate of the requests' arrival from the Internet to the Incoming traffic-handling block in FIG. 2, whereas b is the rate with which the responses arrive to the Response prioritization block from other connections.

So the missing Q-algorithm inputs are the instant response/request ratio R and delay tauRtt. These variables cannot be observed directly and have to be calculated from the request and response traffic streams f and b.

In the continuous-traffic case the response traffic rate b as a function of time can be presented as

$$b ( t ) = {{\int }_{0}}^{+ ∞} x ( t - τ ) Rt ( t - τ ) r ( τ ) ⅆ τ \qquad ( 61 )$$

Here Rt(t) is the ‘true’ theoretical response/request ratio—its value determines how much response data would eventually arrive for every byte of the request broadcast x. The function r(tau) describes the response delay distribution over time—this normalized function (its integral from zero to infinity is equal to 1) defines the share of responses that are caused by the requests that were broadcast tau seconds ago.

Naturally, both Rt(t) and r(tau) are not known to us and can change rapidly over time. Actually, r(tau) function in (61) should be properly written as r(t−tau, tau) to show that the delay distribution varies over time—the first argument t−tau is omitted in (61) in order to make the physical meaning of that equation more clear.

We cannot predict the future responses, so we do not know the value of the function Rt(t) and the shape of the function r(tau)=r(t, tau) at any given moment t—the behavior of the responses that will arrive at the future moments t+tau is not known to us. All we can do is extrapolate the past behavior of these functions. Thus we can define the Q-algorithm input R(t) as:

$$R ( t ) = {{\int }_{0}}^{+ ∞} Rt ( t - τ ) r ( t - τ , τ ) ⅆ τ \qquad ( 62 )$$

The equation (62) describes the past behavior of the GNet in an answer to the requests and does not require any knowledge about its future behavior. All the data samples required by (62) are from the times preceding t, so it is always possible to calculate the instant values for R(t).

The practical steps required to calculate R(t) as defined in (62) are presented below.

8.2.1. Instant Response/Request Ratio.

The instant response/request ratio R(t) is defined by the equation (62). The ‘true’ theoretical response/request ratio Rt(t) defines how many bytes would eventually arrive in response to every byte of requests sent out at time t. The ‘delay function’ r(t, tau) defines the delay distribution for the requests sent at time t; this function is normalized—its integral from zero to infinity equals 1.

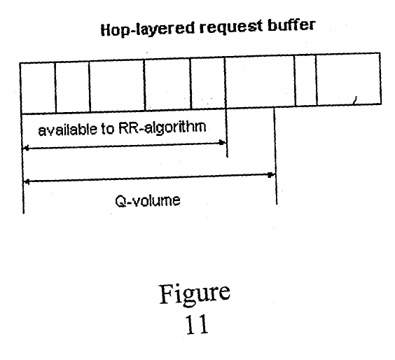

When these functions are multiplied, the result describes both how much and with what delay tau the response data arrives for the requests sent at time t. In the continuous traffic case this resulting response distribution function might look like the one in FIG. 12:

This sample chart shows the product of two continuous functions: the bell-shaped delay function r(tau)=r(t,tau) and the slowly changing true return rate Rt(t). Note that these two functions are presented separately only for the clarity—in real life we almost never can be sure that there won't be any more responses for the request sent at time t, so the precise separate values for R(t) and for r(t, tau) can be found only postfactum, long after the request sending time t. Rt(t)*r(t, tau), however, has no such limitation, and as soon as the current time exceeds t+tau, we have all the information needed to calculate this product on the interval [0, tau].

Essentially the equation (62) defines the latest available estimate for the response/request ratio, using the most recent responses. If we plot its integration trajectory in the same (tau, t) space that is shown in FIG. 12, it will look like a straight line with a −45 degree angle that starts at the current time t and delay tau=0:

This trajectory represents the latest available values for the Rt(t−tau)*r(t−tau,tau) product—the delayed responses that have arrived exactly at the moment t. This can be thought of as a cross-section of the plot in FIG. 12 with the vertical plane defined by the trajectory in FIG. 13.

In the real-life discrete traffic case, however, the calculation of (62) becomes more complicated. The requests and responses are not sent and received continuously as the infinitely small chunks—all networking operations are performed at the discrete time intervals and involve the finite number of bytes.

If we would plot a real-life discrete traffic response distribution in a same fashion as we did in FIG. 12, we would see a mostly zero plot of Rt(t)*r(t, tau) with the finite number of the infinitely high and infinitely thin peaks (delta-functions). Each such peak at the point (tau,t) would represent a response that has arrived after the delay tau for the request sent at time t. Of course, the infinitely high and infinitely thin peaks are just a convenient mathematical abstraction—their meaning is that when the packet arrives, it happens instantly from the application standpoint, so the instant receiving rate is infinite and the integral of this peak is equal to the packet size in bytes.

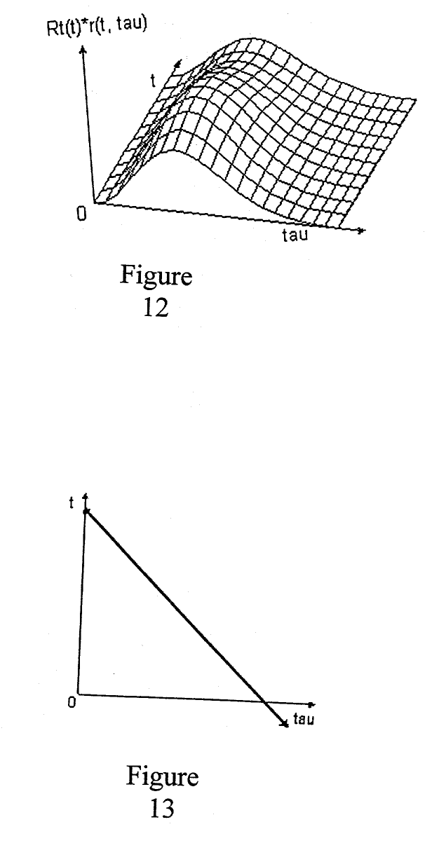

The sample distribution of such peaks in the same (tau, t) space as in FIG. 13 is shown in FIG. 14:

On this chart the thin horizontal lines are the ‘request trajectories’. These lines start at the tau=0 value when the individual requests are sent at the moment t and continue growing as the time goes on. The black marks on the request trajectories represent the individual delayed responses to these requests. The upper right corner of the chart (above the current latest response line) is empty—only the responses received so far are shown on the chart in order to simulate the realistic situation of R(t) being calculated in real time.

The plot in FIG. 14 clearly shows the difficulty of calculating R(t) in the discrete traffic case: unlike the theoretical continuous-traffic plot in FIG. 12, the integration in equation (62) has to be performed along the trajectory that typically does not have even a single non-zero value of the Rt(t−tau)*r(t−tau, tau) product on it. Even when the R(t) calculation is performed exactly at the moment of some response arrival, the integration trajectory still has just a few non-zero points in it, leaving most of the request trajectories (horizontal lines) outside the integration scope.

The reason for this seeming difficulty is that at any current time t_{c} the only samples of the Rt(t)*r(t, tau) product are the ones available at the moments tⱼ, where tⱼ is the time when the request j has been forwarded to other connections for broadcast. At these times the value of Rt(tⱼ)*r(tⱼ, tau) is defined and available for all delay values of tau not exceeding t_{c}−tⱼ—it is zero most of the time and is a delta-function with some weighting coefficient otherwise. However, at all other times t!=tⱼ the value of the Rt(t)*r(t, tau) product is unavailable. That does not mean that it does not exist, but rather that it is not directly observable. If some request would be broadcast at that time t, that fact would define the value of Rt(t)*r(t, tau) product along this request trajectory.

So the integration suggested by the plot in FIG. 14 has a logical flaw—it attempts to perform an operation (62) designed for the function that is defined everywhere on the (tau,t) plane, using the function that is defined only along the finite number of lines t=tⱼ instead. In order to perform this operation in a correct fashion we need to make the Rt(t)*r(t, tau) product value available not only at the points (tau, t) that correspond to the ‘request trajectories’, but at all other points too. Given the amount of information we have from observing the GRouter traffic, an only feasible way of achieving that is the interpolation. We have to define this function for all times t!=tⱼ when it is not directly observable, using just the information from times t=tⱼ.

In order to do that, we can act as if the requests and responses are not sent and received instantly, but gradually with finite transfer rates defined as the message sizes divided by the interval between the requests. Then the request with the size Vfⱼ is not sent instantly at the moment tⱼ, but gradually with a finite rate x[tⱼ, tⱼ₊₁[=Vfⱼ/(tⱼ₊₁−tⱼ) defined on the whole interval [tⱼ, tⱼ₊₁[(note that the time tⱼ₊₁ is not included into the interval—the x(tⱼ₊₁) value is defined by the next request size). Thus the whole range of t is covered by these intervals and x(t) becomes non-zero everywhere. Let us use the index i to mark the responses to the individual request j. Since the response i to the request j is received with the delay tauᵢⱼ, this response will be also delivered gradually over the [tⱼ+tauᵢⱼ, tⱼ₊₁+tauᵢⱼ[interval, and if the response size is Vbᵢⱼ, the effective data transfer rate for this response will be bᵢⱼ[tⱼ+tauᵢⱼ, tⱼ₊₁+tauᵢⱼ[=Vbᵢⱼ/(tⱼ₊₁−tⱼ).

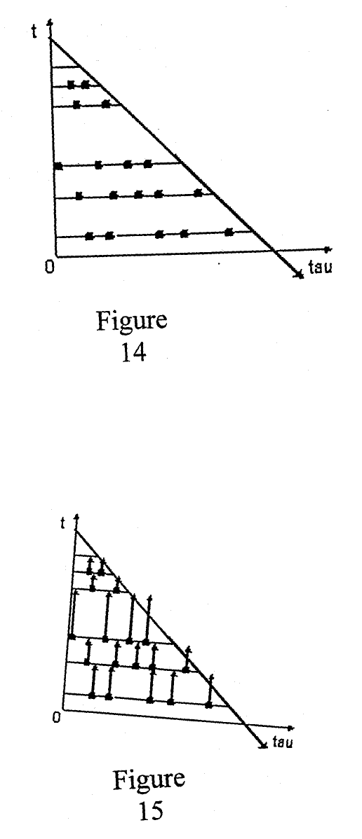

This traffic-‘smoothening’ operation preserves the integral characteristics of the data transfers, and defines the Rt(t)*r(t, tau) product for all values of t—not only for t=tⱼ, allowing us to transform the plot in FIG. 14 into the one shown in FIG. 15:

The vertical arrows in FIG. 15 represent the non-zero values of the Rt(t)*r(t, tau) product and cover the interval [tⱼ, tⱼ₊₁[from the request sending time tⱼ up to but not including the next request sending time tⱼ₊₁. When t=tⱼ₊₁, the new request data is used. These non-zero values are actually the delta-functions of tau with the magnitude defined by the fact that these delta-functions are supposed to convert the request sending rate x(t) into the response receiving rate b(t) according to the equation (61).

We have already seen that the response i to the request j effectively increases the response rate on the [tⱼ+tauᵢⱼ, tⱼ₊₁+tauᵢⱼ[interval by Vbᵢⱼ/(tⱼ₊₁−tⱼ), and that this increase is caused by the request with rate Vfⱼ/(tⱼ₊₁−tⱼ) on the interval [tⱼ, tⱼ₊₁[. In terms of the equation (61), this additional response rate is caused by the Rt(t−tauᵢⱼ)*r(t−tauᵢⱼ, tauᵢⱼ) product multiplied by the x(t−tauᵢⱼ) (equal to Vfⱼ/(tⱼ₊₁−tⱼ)) and by the infinitely small value dtau, so we can write this response rate increment as

Vbᵢⱼ/(tⱼ₊₁−tⱼ)=Vfⱼ/(tⱼ₊₁−tⱼ)*Rt(t−tauᵢⱼ)*r(t−tauᵢⱼ, tauᵢⱼ)*dtau, (63)

or

Vbᵢⱼ=Vfⱼ*Rt(t−tauᵢⱼ)*r(t−tauᵢⱼ, tauᵢⱼ)*dtau. (64)

This allows us to write the Rt(t)*r(t, tauᵢⱼ) product value on the [tⱼ, tⱼ₊₁[interval as

Rt([tⱼ . . . tⱼ₊₁[)*r([tⱼ . . . tⱼ₊₁[, tauᵢⱼ)=(Vbᵢⱼ/Vfⱼ)*delta(tau−tauᵢⱼ), (65)

where delta(tau-tauᵢⱼ) is a function which is infinite with an integral of 1 when tau=tauᵢⱼ and zero when tau!=tauᵢⱼ.

Equation (65) makes it possible to calculate the R(t) as defined in (62) in the discrete traffic case. The continuous-space integral (62) becomes the sum, which components correspond to the non-zero points on the integration trajectory. In FIG. 15 these non-zero points can be easily seen as the vertical arrows that cross the integration trajectory. Note also that since several requests can be forwarded for broadcast at the same sending time tⱼ, this group of requests is considered a single request j from the interpolation standpoint. All the replies to this group of requests are considered to be the replies to the request j.

However, even though this straightforward approach to the R(t) computation is possible in principle, it is rather complicated in implementation and might lead to the various Q-algorithm computational errors and decreased code performance. The main problem with this integration method is that it does not take into consideration the reason for the R(t) computation, which is the subsequent exponential averaging (53) and using the resulting Rav value as the Q-algorithm input. Equation (62) allows us to calculate the value of R(t) at any random moment t, which is first, not necessary (ultimately we need only the averaged value Rav for the Q-algorithm), and second, results in a noisy and imprecise R(t) function. In fact, it can be shown that when the time scale is discrete (as it normally is in any computer system), the integration approach illustrated in FIG. 15 leads to a systematic error proportional to the operating system ‘time quantum’—the precision of the built-in computer clock.

The Q-algorithm equation (53) requires R(t) that would correctly reflect all the response data arriving within the Q-algorithm time step Tq. The integration presented in FIGS. 13-15 effectively counts only the very latest responses; if the Q-algorithm step time is big enough, many of the responses won't be factored into the R(t) calculation as defined in (62), which might be a source of the Rav (and Q-algorithm) errors.

So we need R(t) to be not an ‘instant’ response/request ratio at time t, but rather some ‘average’ value on the [t−Tq,t] interval, and this ‘real-life’ R(t) should be related to the Q-algorithm step size Tq, factoring all the responses arriving on this interval into the calculation. In order to do that, we can define the Q-algorithm input R at the current time t_{c} as R(t_{c}, Tq), which is the average value of R(t) integral (62) on the Q-algorithm step interval [t_{c}−Tq, t_{c}]:

$$R ( {t}_{c} , Tq ) = \frac{1}{Tq} {\int }_{{t}_{c} - Tq}^{{t}_{c}} {\int }_{0}^{+ ∞} Rt ( t - τ ) r ( t - τ , τ ) ⅆ τ ⅆ {t}_{} \qquad ( 66 )$$

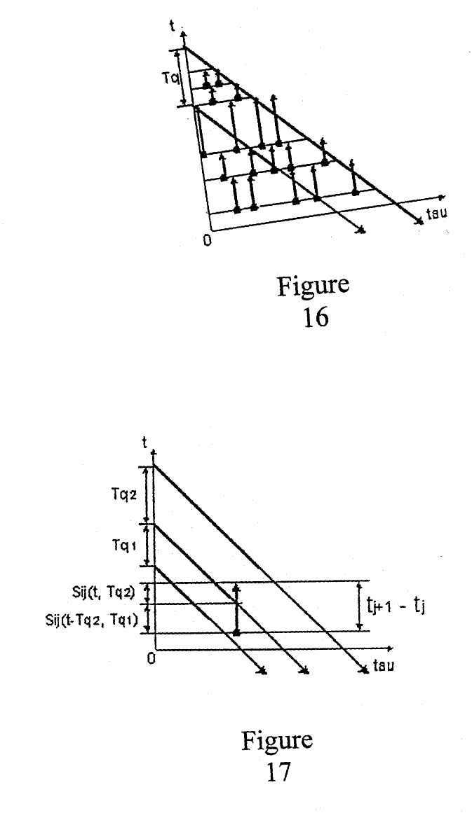

This integration approach is illustrated in FIG. 16.

Here the same response pattern as in FIG. 14 and FIG. 15 is presented together with the Q-algorithm step size Tq. Instead of calculating the value of R(t) as suggested by FIG. 15 and equation (62), here all the responses that have the ‘interpolation arrows’ inside the two-dimensional integration area (shaded area in FIG. 16) are included into the equation. After the two-dimensional integral is calculated, it is divided by Tq to compute R(t, Tq).

It is important to realize that the integration approaches suggested in FIG. 15 (equation (62)) and FIG. 16 (equation (66)) become identical when the Q-algorithm step size Tq→0. We are not introducing a new definition for R(t) here—we just present the discrete Q-algorithm time case approximation of the same basic function, which in the continuous Q-algorithm time case is defined by the integration along the trajectory shown in FIGS. 13-15 (equation (62)). The two-dimensional integration presented in FIG. 16 is necessary because of the finite size of the Q-algorithm step time Tq, and not because of the discrete character of the traffic. Even if the Rt(t)*r(t, tau) product would be similar to the one shown in FIG. 12 and the data would be sent and received continuously in the infinitely small chunks, the two-dimensional integral (66) would still be necessary when Tq>0.

The discrete (finite message size) traffic, however, is the cause of the delta-function appearance in the equation (65) and of the finite-length ‘interpolation arrows’ in FIGS. 15 and 16. So the practical computation of (66) in the discrete traffic case involves the finite number of responses—the ones that have the ‘interpolation arrows’ at least partly within the shaded integration area in FIG. 16. The value of every sum component is proportional to Vbᵢⱼ/Vfⱼ (see (65)) and to the length of the ‘interpolation arrow’ segment within the integration area.

FIG. 16 makes it is easy to see that the response ‘interpolation arrow’ crosses the integration trajectory only if this response arrival time tⱼ+tauᵢⱼ is more recent than the current time t minus the Q-algorithm step size Tq and minus the request interval tⱼ₊₁−tⱼ. So the non-zero components of the sum that replaces (66) in the discrete traffic case must satisfy the condition

| | | | |
|---|---|---|---|
| (67) | tⱼ + tauᵢⱼ > t − Tq − (tⱼ₊₁ − tⱼ), | or | tauᵢⱼ > t − Tq − tⱼ₊₁ |

Introducing the ‘response age’ variable aᵢⱼ=t=(tⱼ+tauᵢⱼ), we can write this as:

| | | |
|---|---|---|
| (68) | aᵢⱼ < Tq + (tⱼ₊₁ − tⱼ), | if j is not the last request sent out, |
| (69) | aᵢⱼ >= 0, | if j is the last request sent out (all its |
| | | responses are counted). |

These conditions mean that only the relatively recent responses should participate in the R(t) calculation, and the maximal age of such responses should be calculated individually for every request.

Defining the length of the ‘interpolation arrow’ part that is within the integration area as Sᵢⱼ=Sᵢⱼ(t,Tq) (it is written here as a function of t and Tq to underscore that for every response this value depends on time and on the Q-algorithm step size), from (65) and (66) we can find R(t, Tq) as:

$$\begin{matrix}R ( t , Tq ) = \frac{1}{Tq} {\sum }_{i , j}^{} \frac{{Vb}_{ij}}{{Vf}_{j}} {S}_{ij} \vert \begin{matrix} {a}_{ij} < Tq + ( {t}_{j + 1} - {t}_{j} ) , if j is not the last request \\ {a}_{ij} >= 0 , if j is the last request\end{matrix} & ( 70 ) \\ & \end{matrix}$$

It is not difficult to find Sᵢⱼ at any given moment t, so the equation (70) can be actually implemented, giving the correct R value for the Q-algorithm equation (53).

In practice, however, it is not very convenient to use the equation (70). From FIG. 16 it is clear that this sum contains not only the components related to the responses that have arrived during the last Q-algorithm step Tq, but also the components related to the responses received before that. So the responses' parameters (size and arrival time) have to be stored in some lists until the corresponding response ages exceed the age limit (68). On every Q-algorithm step these lists have to be traversed to determine the old responses to be removed, then the new Sᵢⱼ parameters have to be found for the remaining responses and only after that the sum (70) can be found.

This whole process is complicated and time-consuming, so it might be desirable to optimize it. In order to do that, let us notice that as the Tq grows and the relevant ‘interpolation arrows’ have bigger chance to be fully inside the integration area, the average Sᵢⱼ value approaches tⱼ₊₁−tⱼ. And in any case, the ‘interpolation arrow’ of every response is going to be eventually ‘fully covered’ by the integration (66) on some Q-algorithm step. Since there are no time gaps between the Q-algorithm steps, the integration areas similar to the one in FIG. 16 cover the whole tau>0 space, and every point on every ‘arrow’ is going to belong to exactly one Sᵢⱼ(t,Tq) interval.

Further, the equations (66) and (70) were designed to average the ‘instant’ value of R(t) defined by the equation (62) over the Q-algorithm step time Tq, and for every two successive Q-algorithm steps Tq1 and Tq2,

R(t, Tq1+Tq2)=(R(t, Tq2)*Tq2+R(t−Tq2, Tq1)*Tq1)/(Tq1+Tq2), (71)

which means that the R value for the bigger Q-algorithm step can be found as a weighted average of the R values for the smaller steps. Let us consider the model situation when there is a single response Vbᵢⱼ and its ‘interpolation arrow’ falls into two Q-algorithm steps—Tq1 and Tq2, as shown in FIG. 17.

Here the response ‘arrow’ is split into two parts Sᵢⱼ(t, Tq2) and Sᵢⱼ(t−Tq2, Tq1), so

tⱼ₊₁−tⱼ=Sᵢⱼ(t, Tq2)+Sᵢⱼ(t−Tq2, Tq1). (72)

In this case the R values for these two Q-algorithm steps Tq1 and Tq2 calculated with the equation (70) are:

R(t, Tq2)=(Vbᵢⱼ/Vfⱼ)*Sᵢⱼ(t, Tq2)/Tq2, (73)

and

R(t−Tq2, Tq1)=(VbᵢⱼVfⱼ)*Sᵢⱼ(t−Tq2, Tq1)/Tq1. (74)

The R value for the compound step Tq1+Tq2 is

R(t, Tq1+Tq2)=(Vbᵢⱼ/Vfⱼ)*(Sᵢⱼ(t, Tq2)+Sᵢⱼ(t−Tq2, Tq1))/(Tq1+Tq2). (75)

Using (72), we can present (75) as

R(t, Tq1+Tq2)=(Vbᵢⱼ/Vfⱼ)*(tⱼ₊₁−tⱼ)/(Tq1+Tq2), (76)

meaning that as the R value is being averaged over time, it does not really matter whether the response is being counted in the sum (70) precisely (according to the Sᵢⱼ value), or the response is just assigned to the Q-algorithm step where it was received. For example, if we simplify the R calculation and compute the R values on the two Q-algorithm steps above as:

R(t, Tq2)=0, and (77)

R(t−Tq2, Tq1)=(Vbᵢⱼ/Vfⱼ)*(tⱼ₊₁−tⱼ)/Tq1, (78)

the averaged R value on these two steps will be:

R(t, Tq1+Tq2)=(Vbᵢⱼ/Vfⱼ)*(tⱼ₊₁−tⱼ)/(Tq1+Tq2), (79)

which is identical to (76). So even though the equations (77) and (78) give us the non-precise values of the integral (66) on two individual Q-algorithm steps Tq1 and Tq2, it is a very short-term error. The averaged R value on the compound interval Tq1+Tq2 defined by (79) is exactly the one defined by the averaging of the precise R values calculated in (73) and (74).

Now, since the R value is used by the Q-algorithm only as an input to the equation (53) that exponentially averages it with the characteristic time tauAv, we can disregard the short-term irregularities in R and replace the equation (70) by the following optimized equation:

$$R ( t , Tq ) = \frac{1}{Tq} {\sum }_{i , j}^{} \frac{{Vb}_{ij}}{{Vf}_{j}} ( {t}_{j + 1} - {t}_{j} ) \vert {a}_{ij} < Tq \qquad ( 80 )$$

Even though the equation (80) is less precise than the equation (70), its precision is sufficient for our purposes when tauAv>tⱼ₊₁−tⱼ. At the same time the implementation of the equation (80) is much simpler, requiring less memory and CPU cycles. Only the responses arriving within the latest Q-algorithm step time have to be counted, the complicated Sᵢⱼ calculations do not have to be performed on every Q-algorithm step, and the memory requirements are minimal. Nothing has to be stored on ‘per response’ basis, and for every request in the routing table, just the value of the (tⱼ₊₁−tⱼ)/Vfⱼ ratio has to be remembered. Then every arriving response Vbᵢⱼ should increase the sum in the equation (80). When the Q-algorithm step is actually done, this sum should be divided by Tq to calculate R and zeroed immediately after that to prepare for the next Q-algorithm step. This approach also makes it possible to ‘spread’ the calculations more evenly over the Q-algorithm time step Tq instead of performing all the computations at once, as it would be the case with the equation (70).

Of course, the last request sent out should still be treated in a special way—the next request sending time tⱼ₊₁ is unavailable for it, so all its responses should be added to the sum (80) when the Q-algorithm step is actually performed. The current time t should be used instead of tⱼ₊₁ in the equation (80) for this request, since (t−tⱼ)/Vfⱼ would provide the best current estimate of the 1/x(t) value at this point instead of (tⱼ₊₁−tⱼ)/Vfⱼ that is used as the 1/x([tⱼ, tⱼ₊₁[) estimate for all other (previous) requests.

8.2.2. Instant Delay Value.

The instant delay value tauRtt(t) is the measure of how long does it take for the responses to the request to arrive. The word ‘instant’ here does not imply that the responses arrive instantly—it just means that this function provides an instant ‘snapshot’ of the delays observed at the current time t.

Logically this function is a weighted average value of the observed response delays tau. ‘Weighted’ here means that the more is the amount of data in the responses with the delay tau, the bigger influence should this delay value have on the value of tauRtt(t). This is similar to the way the instant response ratio is calculated in (62), so in principle Rt might be just replaced by tau in that equation, leading us to the following equation for tauRtt(t):

$${τ}_{rtt} ( t ) = {\int }_{0}^{+ ∞} τ \cdot r ( t - τ , τ ) ⅆ τ \qquad ( 81 )$$

Unfortunately the previous section (8.2.1) shows that in practice the function r(t, tau) cannot be known to us—we can never be sure that all the responses for some particular request have already arrived, and these future delayed responses might affect the past values of r(t, tau). This happens because by definition the function r(t, tau) is normalized—the integral of r(t, tau)*dtau from zero to infinity is 1. In real-life situations at any current time t we do not see the full response pattern for the request j sent at time tⱼ, but are limited to the requests that have arrived with the delay less or equal to tau=t−tⱼ. The normalization requirement means that any new responses arriving after that will change the past values of r(tⱼ, tau) too, even though the responses that form this function at the values of tau<t-tⱼ have been already received.

Besides, the equation (81) uses the same integration trajectory as the equation (62)—the one shown in FIG. 13. So even if we would somehow know the precise values of the r(t, tau) function, the integral of r(t−tau, tau)*dtau along this trajectory would not be equal to 1 anyway—the function r(t, tau) is normalized only for the horizontal integration trajectories t=const in the (tau, t) space. Thus the direct calculation of (81) would give us the wrong value of tauRtt when r(t, tau) changes with t, as it normally does.

So what we need is some practically feasible and properly normalized way to average the response delay tau. This amounts to a requirement to have some function to replace r(t−tau, tau) in (81). The solution presented uses the Rt(t−tau)*r(t−tau, tau) product for this purpose.

As an averaging multiplier for tau, this function has some very attractive properties: first, its calculation does not require any knowledge about the future data, which means that the future responses won't change the values that we already have.

Second, this function is pretty close to the r(t−tau, tau), differing only by the true response/request ratio value Rt, and it can be argued that this multiplier actually makes sense from the averaging standpoint. For example, the requests with many responses would have stronger influence on the tauRtt, meaning that generally tauRtt would be closer to the average response time for the requests that provide the bulk of the return traffic.

Third, as long as the function used for the tau averaging instead of r(t−tau, tau) in (81) has some defensible relationship to the response distribution pattern r(t−tau, tau) (as Rt(t−tau)*r(t−tau, tau) product certainly does), it is a matter of the secondary importance, which particular function is used. The tauRtt(t) variations due to the different averaging function choice can be countered by the appropriate choice of the negative feedback coefficient beta for the equations (50) and (53-55), since the value of tauRtt just controls the Q-algorithm convergence rate and does not affect anything else. In fact, even that function of tauRtt is present only when the response bursts with rate b>B are observed. Normally, when there's no response burst and tauRtt is not very big (tauRtt<tauMax), the Q-algorithm convergence speed is limited by the bigger time tauMax anyway, as defined by (56). In practice, being close to r(t−tau, tau), our particular averaging function choice does not require changing beta from its recommended value of 1.0.

And finally, we are calculating the values related to the Rt(t−tau)*r(t−tau, tau) product and its integral anyway when we are calculating R(t) as described in section 8.2.1.

The only unattractive property of Rt(t−tau)*r(t−tau, tau) product as an averaging function is that its integral is not normalized to 1 over the integration trajectory shown in FIG. 13. However, this is easily fixed by explicitly normalizing this product by dividing it by R(t), which is exactly the value of this integral (62) over the integration trajectory in FIG. 13.

So we can present the expression for tauRtt(t) as:

$${τ}_{rtt} ( t ) = \frac{1}{R ( t )} {\int }_{0}^{+ ∞} τ \cdot {R}_{t} ( t - τ ) r ( t - τ , τ ) ⅆ τ \qquad ( 82 )$$

Applying the same line of reasoning as the one applied in section 8.2.1 to the similar equation (62), in the discrete traffic case we can replace (82) by a finite sum

$${τ}_{rtt} ( t ) = \frac{1}{R ( t ) \cdot Tq} {\sum }_{i , j}^{} \frac{{τ}_{ij} {Vb}_{ij}}{{Vf}_{j}} ( {t}_{j + 1} - {t}_{j} ) \vert {a}_{ij} < Tq \qquad ( 83 )$$

in the same fashion as we have replaced (62) by its discrete-traffic representation (80). Here the sum components are calculated in a fashion similar to (80)—in fact, both sums (80) and (83) can be calculated in parallel as the responses arrive, and then the value of R(t) from (80) can be used to normalize the sum in (83) to calculate the tauRtt(t) value.

The same last request treatment rules that were described in section 8.2.1 for the equation (80) apply to the equation (83). All responses to this request should be included into the sum (83) and the current time t should be used instead of the next request sending time tⱼ₊₁.

Naturally, the equation (83) is inapplicable when R(t)=0. Consider the case when on the average there's less than one response per request j (actually, request group j). This situation is particularly likely to arise when the number of requests in the average request group j is small. Then on the average there's likely to be no non-zero response components in (80) and (83), meaning that both R(t) and the sum in (83) would be equal to zero. In that case the previous value of tauRtt should be used. If no previous tauRtt values are available, that means that the connection was just opened and no requests forwarded by it for broadcast to other connections have resulted in the responses yet. Then we cannot estimate R(t) and tauRtt(t), so the initial conditions described in Section 8.2 (equation (60)) should apply to x(t) and tauRtt=0 should be used in (56).

When tauRtt(t) is calculated on the basis of just a few data samples (or even a single data sample), the value of tauRtt(t) might have a big variance. Of course, the same would be also true for the R(t) function, but that function is used by the Q-algorithm only after the averaging over the tauAv time period (equation (53)). The tauRtt(t), on the contrary, is used directly in (56), since it is this value that might be defining the averaging interval for all other equations ((50) and (53-55)), and it might be difficult to average it exponentially in a similar fashion.

Fortunately the value of tauRtt is used only when the long response traffic burst is present or when tauRtt>tauMax (56). Otherwise, the constant value tauMax (56) defines the Q-algorithm convergence rate, so normally tauRtt is not used by the Q-algorithm at all. But even when it is used by the Q-algorithm, it just defines the algorithm convergence speed and if the general numerical integration guidelines presented in Appendix B are observed, the big tauRtt variance should not present a problem.

However, the extremely high variance of tauRtt is still undesirable, so it is recommended to calculate tauRtt on the basis of at least 10 response samples or so, increasing the Tq averaging interval in the equation (83) if necessary. This is made even more important by the fact that the equation (83) is the analog of the optimized approximation (80) for R(t) and not of the precise equation (70), which might lead to the higher variance of tauRtt because of this approximate computation. Thus the bigger averaging interval Tq might be desirable, so that the average interval tⱼ₊₁−tⱼ between requests would be less than Tq, since tⱼ₊₁₋ₜⱼ<<Tq is the condition required for the approximate solution (80) to converge to the precise solution (70).

Finally it should be noted that the interaction between the Q-algorithm and the RR-algorithm and OFC block described in section 8.1 makes it very difficult to determine whether the individual request was sent out or not. This information would have to be communicated in a complicated fashion from the RR-algorithms of several connection blocks to the Q-algorithm of the connection block that has received the request. In principle it is possible to do so; however, it is much simpler to consider every request passing through the Q-algorithm ‘partially broadcast’ with the request size equal to

Vef=Vreq*(x(t)/f(t)), (84)

where Vreq is the actual request message size, x(t)/f(t) is the Q-algorithm output and Vef is the resulting effective request size. The Vfⱼ value to be used in the equations (80) and (83) is defined as:

Vfⱼ=sum(Vef) (85)

for all the requests forwarded on the current Q-algorithm step.

The effective request size Vef is essentially the ‘desired number of bytes’ to be broadcast from this request as defined in section 8.1—that's how many request bytes the Q-algorithm would wish to broadcast if it would be possible to broadcast just a part of the request. This value is associated with the request when it is passed to the OFC block. Vfⱼ is the summary desired number of bytes to send on the current Q-algorithm step. This value (or the related (tⱼ₊₁−tⱼ)/Vfⱼ value) is associated with every request in the routing table and is used in the equations (80) and (83).

Since the actual requests are atomic and can be either sent or discarded, this fact also increases the variance of R(t) and tauRtt(t). For example, all the requests forwarded for broadcast on some Q-algorithm step can be actually dropped and thus have no responses, which would result in the zero response traffic caused by the forward data transfer rate x(t) on this Q-algorithm step. And all the requests forwarded on the next Q-algorithm step might be sent out and cause the response traffic that would be disproportional for this step's x(t).

This underscores the need to compute tauRtt(t) only when many (much more than one) response data samples are available for the equation (83). Unlike R(t) that is averaged by (53), tauRtt(t) is being averaged only by the equation (83) itself, and the additional variance arising from the atomic nature of the requests has to be suppressed when tauRtt is computed.

### 9. Recapitulation of Selected Embodiments

This section briefly highlights and identifies and recapitulates particular embodiments of algorithms and architectural decisions introduced in the previous sections. These selections are by way of example and not limitation.

Section 3: The Gnutella router (GRouter) block diagram is introduced. The ‘Connection 0’, or the ‘virtual connection’ is presented as the API to the local request-processing block (see Appendix A for the details).

Section 4: The Connection Block diagram is introduced and the basic message processing flow is described.

Section 6.1: The algorithm to determine the desirable network packet size to send is presented (equations (2-4)).

Section 6.2: The algorithms used to determine when the packet has to be sent (G-Nagle and wait time algorithm—equations (9-11)) are described. The algorithm to determine the outgoing bandwidth estimate (equations (13,14)) is presented.

Section 7.1: The simplified bandwidth layout (equations (25,26)) is introduced.

Section 7.2: The method to satisfy the bandwidth reservation requirement by varying the packet layout (equations (39,40)) is presented.

Section 7.3: The ‘herringbone stair’ algorithm is introduced. This algorithm satisfies the bandwidth reservation requirements in the discrete traffic case. The equations (45) and (46) are introduced to determine the outgoing response bandwidth estimate.

Section 7.4: The ‘herringbone stair’ algorithm is extended to handle the situation of multiple incoming data streams.

Section 8.1: The Q-block of the RR-algorithm is introduced. The goal of this block is to provide the interaction between the Q-algorithm and the RR-algorithm in order to minimize the Q-algorithm latency.

Section 8.2: The initial conditions for the Q-algorithm are introduced, including the case of the partially undefined Q-algorithm input (equation (60).

Section 8.2.1: The algorithm to compute the instant response/request ratio for the Q-algorithm is described (equations (68-70)). The optimized method to compute the same value is proposed (equation (80)).

Section 8.2.2: The algorithm for the instant delay value computation (equation (83)) is presented. The methods to compute the effective request size for the OFC block and for the equations (80), (83) are introduced (equations (84) and (85)).

The foregoing descriptions of specific embodiments of the present invention have been presented for purposes of illustration and description. They are not intended to be exhaustive or to limit the invention to the precise forms disclosed, and obviously many modifications and variations are possible in light of the above teaching. The embodiments were chosen and described in order to best explain the principles of the invention and its practical application, to thereby enable others skilled in the art to best utilize the invention and various embodiments with various modifications as are suited to the particular use contemplated. It is intended that the scope of the invention be defined by the claims appended hereto and their equivalents. All publications and patent applications cited in this specification are herein incorporated by reference as if each individual publication or patent application were specifically and individually indicated to be incorporated by reference.

### 10. References

[1] S. Osokine. The Flow Control Algorithm for the Distributed ‘Broadcast-Route’ Networks with Reliable Transport Links. U.S. patent application Ser. No. 09/724,937 filed Nov. 28, 2000 and entitled System, Method and Computer Program for Flow Control In a Distributed Broadcast-Route Network With Reliable Transport Links; herein incorporated by reference an enclosed as Appendix D.

I claim:

1. A method for controlling the flow of information in a distributed computing system, said method comprising:
controlling the outgoing flow of information including requests and responses on a network connection to that no information is sent before previous portions of information are received to minimize connection latency;
controlling the stream of requests arriving on the connection and arbitrating which of said arriving requests should be broadcast to neighbors; and
controlling monopolization of the connection by any particular request/response information stream by multiplexing the competing streams according to some fairness allocation rules.

2. A method for assuring that the response flow does not overload the connection outgoing bandwidth in a communication system.

3. A computer-readable medium whose contents cause a computing device to perform the method of claim 1.

4. A computer system comprising components capable of performing the method of claim 1.
